(19) United States
(12) Patent Application Publication
(10) Pub. No.: US 2026/0282046 A1
(43) Pub. Date: Sep. 17, 2026

(54) DATA TRANSMISSION AVAILABILITY IN S-SSB OCCASIONS

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Giovanni CHISCI, San Diego, CA (US); Changlong XU, Beijing (CN); Shaozhen GUO, Beijing (CN); Luanxia YANG, Beijing (CN)

(21) Appl. No.: 19/471,674

(22) PCT Filed: May 17, 2023
(86) PCT No.: PCT/CN2023/094656

§ 371 Date: Oct. 1, 2025

(51) Int. Cl. H04W 72/25; H04L 27/26

(52) U.S. Cl. CPC H04W 72/25; H04L 27/261

(57) ABSTRACT

Methods, systems, and devices for wireless communication are described. A first user equipment (UE) may receive a first message indicating one or more occasions associated with sidelink synchronization signal block (S-SSB) transmissions between at least the first UE and a second UE. The first UE may transmit, to a network entity, a second message that includes an indication to override a default state associated with whether the one or more occasions are available for sidelink data transmissions. The first UE may communicate one or more reference signals between at least the first UE and the second UE based on transmitting the second message to the network entity. In some examples, the first UE may drop a sidelink data transmission based on a priority value associated with the sidelink data transmission being lower than a priority value associated with an overlapping S-SSB.

### CROSS REFERENCE

This application is a 371 National Stage of PCT Application No. PCT/CN2023/094656, filed on May 17, 2023, entitled “DATA TRANSMISSION AVAILABILITY IN S-SSB OCCASIONS”, and assigned to the assignee hereof. The disclosure of the prior Application is considered part of and is incorporated by reference into this Patent Application.

### FIELD OF TECHNOLOGY

The following relates to wireless communication, including data transmission availability in sidelink synchronization signal block (S-SSB) occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some examples, a UE may engage in sidelink communications with one or more other UEs.

### SUMMARY

The described techniques relate to improved methods, systems, devices, and apparatuses that support data transmission availability in S-SSB occasions. For example, the described techniques provide for a first UE to receive a first message indicating one or more occasions associated with S-SSB transmissions between at least the first UE and a second UE. The first UE may transmit, to a network entity, a second message that includes an indication to override a default state associated with whether the one or more occasions are available for sidelink data transmissions between at least the first UE and the second UE. The first UE may communicate one or more reference signals between at least the first UE and the second UE based on transmitting the second message to the network entity. In some examples, the first UE may drop a sidelink data transmission based on a priority value associated with the sidelink data transmission being lower than a priority value associated with an S-SSB associated with the upcoming occasion, and the first UE may transmit a negative acknowledgment message based on dropping the sidelink data transmission. In some cases, a priority value of the negative acknowledgment message may be a same value as the priority value of the sidelink data transmission.

A method for wireless communication at a first UE is described. The method may include receiving a first message indicating one or more occasions associated with S-SSB transmissions between at least the first UE and a second UE, transmitting, to a network entity, a second message that includes an indication to override a default state, the default state associated with whether the one or more occasions are available for sidelink data transmissions between the first UE and the second UE, and communicating one or more reference signals between at least the first UE and the second UE based on transmitting the second message to the network entity.

An apparatus for wireless communication at a first UE is described. The apparatus may include a processor, memory coupled with the processor, and instructions stored in the memory. The instructions may be executable by the processor to cause the apparatus to receive a first message indicating one or more occasions associated with S-SSB transmissions between at least the first UE and a second UE, transmit, to a network entity, a second message that includes an indication to override a default state, the default state associated with whether the one or more occasions are available for sidelink data transmissions between the first UE and the second UE, and communicate one or more reference signals between at least the first UE and the second UE based on transmitting the second message to the network entity.

Another apparatus for wireless communication at a first UE is described. The apparatus may include means for receiving a first message indicating one or more occasions associated with S-SSB transmissions between at least the first UE and a second UE, means for transmitting, to a network entity, a second message that includes an indication to override a default state, the default state associated with whether the one or more occasions are available for sidelink data transmissions between the first UE and the second UE, and means for communicating one or more reference signals between at least the first UE and the second UE based on transmitting the second message to the network entity.

A non-transitory computer-readable medium storing code for wireless communication at a first UE is described. The code may include instructions executable by a processor to receive a first message indicating one or more occasions associated with S-SSB transmissions between at least the first UE and a second UE, transmit, to a network entity, a second message that includes an indication to override a default state, the default state associated with whether the one or more occasions are available for sidelink data transmissions between the first UE and the second UE, and communicate one or more reference signals between at least the first UE and the second UE based on transmitting the second message to the network entity.

In some examples of the method, apparatuses, and non-transitory computer-readable medium described herein, the second message indicates that the default state is overridden for a next occasion of the one or more occasions.

In some examples of the method, apparatuses, and non-transitory computer-readable medium described herein, the second message indicates that the default state is overridden for occasions within a current S-SSB period.

Some examples of the method, apparatuses, and non-transitory computer-readable medium described herein may further include operations, features, means, or instructions for transmitting, to the network entity, a fourth message that includes an indication to return to the default state for occasions within the current S-SSB period.

Some examples of the method, apparatuses, and non-transitory computer-readable medium described herein may further include operations, features, means, or instructions for transmitting, to the network entity and prior to transmitting the first message, a third message indicating one or more Layer 2 ID values associated with the first UE.

In some examples of the method, apparatuses, and non-transitory computer-readable medium described herein, the default state indicates that the one or more occasions may be available for sidelink data transmissions between the first UE and the second UE.

In some examples of the method, apparatuses, and non-transitory computer-readable medium described herein, the default state indicates that the one or more occasions may be not available for sidelink data transmissions between the first UE and the second UE.

Some examples of the method, apparatuses, and non-transitory computer-readable medium described herein may further include operations, features, means, or instructions for transmitting, based on the default state being overridden, a sidelink data message to the second UE during a next occasion of the one or more occasions.

In some examples of the method, apparatuses, and non-transitory computer-readable medium described herein, communicating the one or more reference signals may include operations, features, means, or instructions for communicating the one or more reference signals during an occasion that follows the next occasion of the one or more occasions.

Some examples of the method, apparatuses, and non-transitory computer-readable medium described herein may further include operations, features, means, or instructions for transmitting, to the network entity, a fourth message that includes an indication to return to the default state for occasions within a current S-SSB period, where communicating the one or more reference signals may be based on transmitting the fourth message.

In some examples of the method, apparatuses, and non-transitory computer-readable medium described herein, the default state may be based on a success rate associated with listen-before-talk procedures for S-SSB transmissions at the first UE.

In some examples of the method, apparatuses, and non-transitory computer-readable medium described herein, the indication to override the default state includes one or more bits within the second message, the second message including an uplink control message.

In some examples of the method, apparatuses, and non-transitory computer-readable medium described herein, transmitting the second message may include operations, features, means, or instructions for transmitting the uplink control message during a time window configured by the network entity, where the one or more bits include one or more additional bits included in the second message based on transmitting the uplink control message during the time window.

In some examples of the method, apparatuses, and non-transitory computer-readable medium described herein, the second message includes a dedicated control message associated with transmitting the indication to override the default state.

Some examples of the method, apparatuses, and non-transitory computer-readable medium described herein may further include operations, features, means, or instructions for receiving, from the second UE, a message that includes the indication to override the default state, where transmitting the second message to the network entity may be based on receiving the message that includes the indication to override the default state from the second UE.

Some examples of the method, apparatuses, and non-transitory computer-readable medium described herein may further include operations, features, means, or instructions for determining that an upcoming occasion of the one or more occasions associated with S-SSB transmissions overlaps with an occasion for a sidelink data transmission, dropping the sidelink data transmission based on a priority value associated with the sidelink data transmission being lower than a priority value associated with a S-SSB transmission associated with the upcoming occasion, and transmitting a negative acknowledgment message based on dropping the sidelink data transmission, where a priority value associated with the negative acknowledgment message may be a same value as the priority value associated with the sidelink data transmission.

A method for wireless communication at a network entity is described. The method may include transmitting, to a first UE, a first message indicating one or more occasions associated with S-SSB transmissions between at least the first UE and a second UE, receiving a second message that includes an indication to override a default state, the default state associated with whether the one or more occasions are available for sidelink data transmissions between the first UE and the second UE, and scheduling one or more sidelink data transmissions between at least the first UE and the second UE for one or more resources that are selected based on least in part on the default state being overridden.

An apparatus for wireless communication at a network entity is described. The apparatus may include a processor, memory coupled with the processor, and instructions stored in the memory. The instructions may be executable by the processor to cause the apparatus to transmit, to a first UE, a first message indicating one or more occasions associated with S-SSB transmissions between at least the first UE and a second UE, receive a second message that includes an indication to override a default state, the default state associated with whether the one or more occasions are available for sidelink data transmissions between the first UE and the second UE, and schedule one or more sidelink data transmissions between at least the first UE and the second UE for one or more resources that are selected based on least in part on the default state being overridden.

Another apparatus for wireless communication at a network entity is described. The apparatus may include means for transmitting, to a first UE, a first message indicating one or more occasions associated with S-SSB transmissions between at least the first UE and a second UE, means for receiving a second message that includes an indication to override a default state, the default state associated with whether the one or more occasions are available for sidelink data transmissions between the first UE and the second UE, and means for scheduling one or more sidelink data transmissions between at least the first UE and the second UE for one or more resources that are selected based on least in part on the default state being overridden.

A non-transitory computer-readable medium storing code for wireless communication at a network entity is described. The code may include instructions executable by a processor to transmit, to a first UE, a first message indicating one or more occasions associated with S-SSB transmissions between at least the first UE and a second UE, receive a second message that includes an indication to override a default state, the default state associated with whether the one or more occasions are available for sidelink data transmissions between the first UE and the second UE, and schedule one or more sidelink data transmissions between at least the first UE and the second UE for one or more resources that are selected based on least in part on the default state being overridden.

Some examples of the method, apparatuses, and non-transitory computer-readable medium described herein may further include operations, features, means, or instructions for receiving, from the second UE, a third message indicating one or more Layer 2 ID values associated with the second UE, where receiving the second message may be based on receiving the third message from the second UE.

Some examples of the method, apparatuses, and non-transitory computer-readable medium described herein may further include operations, features, means, or instructions for receiving, from the first UE, a sidelink buffer status report indicating one or more destination ID values and determining that a destination ID value of the one or more destination ID values may be associated with the second UE, where scheduling the one or more sidelink data transmissions may be based on the determining.

In some examples of the method, apparatuses, and non-transitory computer-readable medium described herein, the second message indicates that the default state is overridden for a next occasion of the one or more occasions.

In some examples of the method, apparatuses, and non-transitory computer-readable medium described herein, the second message indicates that the default state is overridden for occasions within a current S-SSB period.

Some examples of the method, apparatuses, and non-transitory computer-readable medium described herein may further include operations, features, means, or instructions for receiving a fourth message that includes an indication to return to the default state for occasions within the current S-SSB period.

In some examples of the method, apparatuses, and non-transitory computer-readable medium described herein, the default state indicates that the one or more occasions are not available for sidelink data transmissions between the first UE and the second UE, and scheduling the one or more sidelink data transmissions may include operations, features, means, or instructions for scheduling, based on the default state being overridden, a sidelink data transmission between the first UE and the second UE during an occasion of the one or more occasions based on receiving the second message.

In some examples of the method, apparatuses, and non-transitory computer-readable medium described herein, the default state indicates that the one or more occasions are available for sidelink data transmissions between the first UE and the second UE, and scheduling the one or more sidelink data transmissions may include operations, features, means, or instructions for scheduling a sidelink data transmission between the first UE and the second UE for a resource that may be different than a next occasion of the one or more occasions based on receiving the second message.

In some examples of the method, apparatuses, and non-transitory computer-readable medium described herein, the indication to override the default state includes one or more bits within the second message, the second message including an uplink control message.

A method for wireless communication at a first UE is described. The method may include receiving a message indicating one or more occasions associated with S-SSB transmissions between the first UE and a second UE, where an upcoming occasion of the one or more occasions associated with S-SSB transmissions overlaps with an occasion for a sidelink data transmission, dropping the sidelink data transmission based on a priority value associated with the sidelink data transmission being lower than a priority value associated with a synchronization signal block transmission associated with the upcoming occasion, and transmitting a negative acknowledgment message based on dropping the sidelink data transmission, where a priority value of the negative acknowledgment message is a same value as the priority value of the sidelink data transmission.

An apparatus for wireless communication at a first UE is described. The apparatus may include a processor, memory coupled with the processor, and instructions stored in the memory. The instructions may be executable by the processor to cause the apparatus to receive a message indicating one or more occasions associated with S-SSB transmissions between the first UE and a second UE, where an upcoming occasion of the one or more occasions associated with S-SSB transmissions overlaps with an occasion for a sidelink data transmission, drop the sidelink data transmission based on a priority value associated with the sidelink data transmission being lower than a priority value associated with a synchronization signal block transmission associated with the upcoming occasion, and transmit a negative acknowledgment message based on dropping the sidelink data transmission, where a priority value of the negative acknowledgment message is a same value as the priority value of the sidelink data transmission.

Another apparatus for wireless communication at a first UE is described. The apparatus may include means for receiving a message indicating one or more occasions associated with S-SSB transmissions between the first UE and a second UE, where an upcoming occasion of the one or more occasions associated with S-SSB transmissions overlaps with an occasion for a sidelink data transmission, means for dropping the sidelink data transmission based on a priority value associated with the sidelink data transmission being lower than a priority value associated with a synchronization signal block transmission associated with the upcoming occasion, and means for transmitting a negative acknowledgment message based on dropping the sidelink data transmission, where a priority value of the negative acknowledgment message is a same value as the priority value of the sidelink data transmission.

A non-transitory computer-readable medium storing code for wireless communication at a first UE is described. The code may include instructions executable by a processor to receive a message indicating one or more occasions associated with S-SSB transmissions between the first UE and a second UE, where an upcoming occasion of the one or more occasions associated with S-SSB transmissions overlaps with an occasion for a sidelink data transmission, drop the sidelink data transmission based on a priority value associated with the sidelink data transmission being lower than a priority value associated with a synchronization signal block transmission associated with the upcoming occasion, and transmit a negative acknowledgment message based on dropping the sidelink data transmission, where a priority value of the negative acknowledgment message is a same value as the priority value of the sidelink data transmission.

Some examples of the method, apparatuses, and non-transitory computer-readable medium described herein may further include operations, features, means, or instructions for transmitting one or more reference signals to the second UE based on dropping the sidelink data transmission.

Some examples of the method, apparatuses, and non-transitory computer-readable medium described herein may further include operations, features, means, or instructions for transmitting, to a network entity, a message that includes an indication to override a default state, the default state associated with whether the one or more occasions can be used for sidelink data transmissions between the first UE and the second UE.

A method for wireless communication at a network entity is described. The method may include transmitting a message indicating one or more occasions associated with S-SSB transmissions between a first UE and a second UE, where an upcoming occasion of the one or more occasions associated with S-SSB transmissions overlaps with an occasion for a sidelink data transmission and receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

An apparatus for wireless communication at a network entity is described. The apparatus may include a processor, memory coupled with the processor, and instructions stored in the memory. The instructions may be executable by the processor to cause the apparatus to transmit a message indicating one or more occasions associated with S-SSB transmissions between a first UE and a second UE, where an upcoming occasion of the one or more occasions associated with S-SSB transmissions overlaps with an occasion for a sidelink data transmission and receive, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

Another apparatus for wireless communication at a network entity is described. The apparatus may include means for transmitting a message indicating one or more occasions associated with S-SSB transmissions between a first UE and a second UE, where an upcoming occasion of the one or more occasions associated with S-SSB transmissions overlaps with an occasion for a sidelink data transmission and means for receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

A non-transitory computer-readable medium storing code for wireless communication at a network entity is described. The code may include instructions executable by a processor to transmit a message indicating one or more occasions associated with S-SSB transmissions between a first UE and a second UE, where an upcoming occasion of the one or more occasions associated with S-SSB transmissions overlaps with an occasion for a sidelink data transmission and receive, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

Some examples of the method, apparatuses, and non-transitory computer-readable medium described herein may further include operations, features, means, or instructions for receiving, from the first UE, a message that includes an indication to override a default state, the default state associated with whether the one or more occasions can be used for sidelink data transmissions between the first UE and the second UE.

### BRIEF DESCRIPTION OF THE DRAWINGS

FIG. 1 shows an example of a wireless communications system that supports data transmission availability in S-SSB occasions in accordance with one or more aspects of the present disclosure.

FIG. 2 shows an example of a wireless communications system that supports data transmission availability in S-SSB occasions in accordance with one or more aspects of the present disclosure.

FIGS. 3A and 3B show examples of signaling diagrams that support data transmission availability in S-SSB occasions in accordance with one or more aspects of the present disclosure.

FIG. 4 shows an example of a signaling diagram that supports data transmission availability in S-SSB occasions in accordance with one or more aspects of the present disclosure.

FIG. 5 shows an example of a wireless communications system that supports data transmission availability in S-SSB occasions in accordance with one or more aspects of the present disclosure.

FIG. 6 shows an example of a process flow that supports data transmission availability in S-SSB occasions in accordance with one or more aspects of the present disclosure.

FIG. 7 shows an example of a process flow that supports data transmission availability in S-SSB occasions in accordance with one or more aspects of the present disclosure.

FIGS. 8 and 9 show block diagrams of devices that support data transmission availability in S-SSB occasions in accordance with one or more aspects of the present disclosure.

FIG. 10 shows a block diagram of a communications manager that supports data transmission availability in S-SSB occasions in accordance with one or more aspects of the present disclosure.

FIG. 11 shows a diagram of a system including a device that supports data transmission availability in S-SSB occasions in accordance with one or more aspects of the present disclosure.

FIGS. 12 and 13 show block diagrams of devices that support data transmission availability in S-SSB occasions in accordance with one or more aspects of the present disclosure.

FIG. 14 shows a block diagram of a communications manager that supports data transmission availability in S-SSB occasions in accordance with one or more aspects of the present disclosure.

FIG. 15 shows a diagram of a system including a device that supports data transmission availability in S-SSB occasions in accordance with one or more aspects of the present disclosure.

FIGS. 16 through 20 show flowcharts illustrating methods that support data transmission availability in S-SSB occasions in accordance with one or more aspects of the present disclosure.

### DETAILED DESCRIPTION

A first UE may perform sidelink communications with a second UE. In some examples, to align on beams for performing sidelink communications, the first UE and the second UE may communicate one or more reference signals. In some cases, an S-SSB transmission may be configured by a network entity, which may include configuring occasions for the first UE to transmit (e.g., broadcast) one or more reference signals (e.g., S-SSB reference signals) to the second UE and, in some cases, other UEs as part of a broadcast. For example, the network entity may configure (e.g., via a radio resource control (RRC) message) one or more occasions (e.g., including time resources, frequency resources, or both) associated with S-SSB transmissions between at least the first UE and the second UE (e.g., unicast or multi-cast S-SSB transmissions). An S-SSB occasion may refer to a resource or set of resources (e.g., time and frequency resources) via which an S-SSB transmission may potentially occur.

In some cases, however, the one or more occasions associated with S-SSB transmissions configured to the first UE may introduce some inefficiency or scheduling uncertainty at the network entity and the first UE. For example, there may be uncertainty regarding whether the one or more occasions associated with S-SSB transmissions are to be added to a resource pool for sidelink transmissions by the first UE. If the one or more occasions are not added to the resource pool, the first UE would not utilize the resources of the one or more occasions for sidelink data transmissions, which may result in less efficient use of the communication spectrum by the first UE. Meanwhile, if the one or more occasions are added to the resource pool, there may be overlaps between S-SSB transmissions and sidelink data transmissions scheduled by the network entity during the one or more occasions. As such, techniques for resolving these overlaps may be desired, which may enable the network entity to schedule sidelink messages between at least the first UE and the second UE (e.g., unicast or multi-cast sidelink messages) during the one or more occasions without overlapping with S-SSB transmissions.

In accordance with examples as described herein, the first UE 115 may transmit a message including an indication to override a default state associated with whether one or more occasions associated with S-SSB transmissions are available for sidelink data transmissions. For example, a default state may be defined (e.g., based on a success rate of listen-before-talk (LBT) procedures at the first UE) that indicates whether the one or more occasions associated with S-SSB may be used for sidelink data transmissions. For example, the default state may correspond to the one or more occasions not being used for sidelink transmissions, and the first UE may transmit a message including an indication to override the default state if the first UE is to transmit a sidelink data transmission on an upcoming occasion. Alternatively, the default state may correspond to sidelink data transmissions being allowed during the one or more occasions, and the first UE may transmit a message including an indication to override the default state if the first UE is to transmit reference signals associated with an S-SSB on an upcoming occasion. In some cases, the default state may be overridden for the next occasion only, or for all occasions within an S-SSB period until a message including second indication is transmitted to revert to the default state.

Additionally, or alternatively, a first UE may drop a sidelink data transmission if a priority value associated with the sidelink data transmission is below a priority value associated with an overlapping S-SSB transmission. In these examples, the first UE may transmit a negative acknowledgment (e.g., NACK) to a network entity with a priority value equal to that of the dropped sidelink data transmission. Accordingly, the network entity may be aware of the dropped sidelink data transmission and performing scheduling (e.g., retransmission scheduling) accordingly.

Aspects of the disclosure are initially described in the context of wireless communications systems. Aspects of the disclosure are additionally illustrated in the context of signaling diagrams and process flows. Aspects of the disclosure are further illustrated by and described with reference to apparatus diagrams, system diagrams, and flowcharts that relate to data transmission availability in S-SSB occasions.

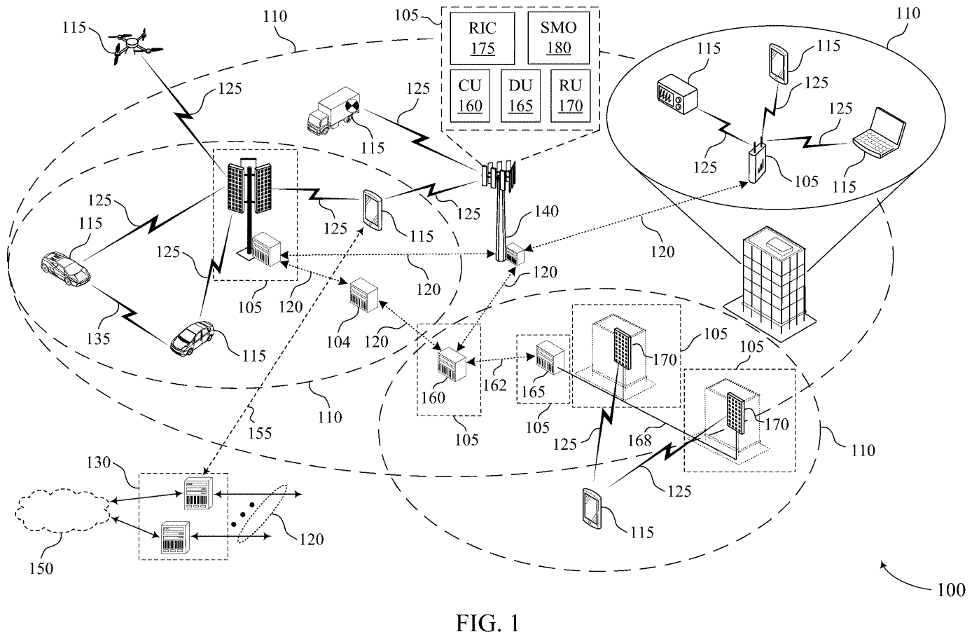

FIG. 1 shows an example of a wireless communications system 100 that supports data transmission availability in S-SSB occasions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support data transmission availability in S-SSB occasions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 or a UE 115 multiple times along different directions. For example, the network entity 105 or the UE 115 may transmit a signal according to different beamforming weight sets associated with different directions of transmission. Transmissions along different beam directions may be used to identify (e.g., by a transmitting device, such as a network entity 105 or a Tx UE 115, or by a receiving device, such as a UE 115 or an Rx UE 115) a beam direction for later transmission or reception by the network entity 105 or the UE 115.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a first UE 115 (e.g., a transmitting or Tx UE) may perform sidelink communications with a second UE 115 (e.g., a receiving or Rx UE). A network entity 105 may indicate or configure the first UE 115 with a grant for performing a sidelink data transmission (e.g., a physical sidelink shared channel (PSSCH) transmission). For example, the network entity 105 may configure the UE 115 with a grant (e.g., a configured grant, such as a type 1 configured grant or a type 2 configured grant), and the network entity may activate the grant by transmitting a downlink control information (DCI) message (e.g., a DCI 3-0 message, for type 2 configured grants) or an RRC message (e.g., for type 1 configured grants) to the first UE 115. Additionally, or alternatively, the network entity 105 may transmit a DCI message (e.g., a DCI 3-0 message) that indicate the first UE 115 of a grant (e.g., a dynamic grant), and the DCI message may provide an allocation (e.g., an occasion, time resources, frequency resources) for the first UE 115 to perform a sidelink data transmission. In some cases, the DCI message (e.g., in the case of dynamic grants) may indicate whether the allocation is for a retransmission of a previous sidelink data transmission (e.g., a dropped transmission, in some cases). In some examples, the first UE 115 may select a modulation and coding scheme (MCS) for the sidelink transmission, though the UE 115 may be configured by the network entity 105 with limits for the MCS.

In some cases, the first UE 115 may be unable to transmit a sidelink data transmission. For example, due to prioritization, the first UE 115 may drop a sidelink data transmission if an overlapping transmission has a higher priority value. In some examples, if the first UE 115 does not transmit a sidelink data transmission in any resources provided by a DCI message (e.g., for a dynamic grant) or any resources provided in a period for which the first UE 115 is provided an uplink control resource (e.g., for a physical uplink control channel (PUCCH) transmission) for reporting HARQ information, the first UE 115 may generate and transmit a NACK to the network entity 105 (e.g., in the uplink control resource). The NACK may, in some examples, have a priority value that is the same as a priority value of the dropped sidelink data transmission.

In some cases, the first UE 115 may also be unable to transmit a sidelink control transmission (e.g., a physical sidelink control channel (PSCCH) transmission). In some examples, if the UE 115 does not transmit a sidelink control transmission (e.g., a PSCCH with a sidelink control information (SCI) with format 1-A) in any resources provided for a grant (e.g., a period for a configured grant, or indicated in a DCI message for a dynamic grant) for which the first UE 115 is provided an uplink control resource for reporting HARQ-ACK information, the first UE 115 may generate and transmit an ACK to the network entity (e.g., in the uplink control resource). In some examples, the ACK may have a priority value that is the same as a largest priority value of the possible priority values for the grant.

In some examples, the first UE 115 may transmit a sidelink buffer status report (SL-BSR) to the network entity 105 (e.g., via a MAC-control element (MAC-CE) message). The SL-BSR may include information regarding sidelink data to be sent out by the first UE 115, which may allow the network entity 105 to schedule sidelink data transmissions. In some examples, the SL-BSR may include one or more control elements, each of which may include a destination index field, a logical channel group (LCG) identification (ID) value (e.g., or identity value), a buffer size value, or any combination thereof, and each may correspond to a reported target group. The destination index may be associated with the destination of the sidelink data (e.g., the second UE 115) and may be set to a corresponding index for a sidelink destination ID for the same destination (e.g., the second UE 115) reported to the network entity 105 in a sidelink information element (e.g., SL-TxResourceReqList, SL-TxResourceReqListDisc, SL-TxResourceReqListCommRelay). In some cases, the destination index for multiple destinations may be indexed sequentially, beginning from 0, in ascending order based on the appearance of the sidelink destination ID in the information element or as presented in a control message (E.g., a sidelink UEInformationNR message).

In some examples, the network entity 105 may configure the first UE 115 with occasions associated with S-SSB transmissions for the first UE 115 to transmit one or more reference signals to the second UE 115. For example, the network entity may configure (e.g., via an RRC message) one or more occasions (e.g., including time resources, frequency resources, or both) associated with S-SSB transmissions (e.g., broadcast) between at least the first UE 115 and the second UE 115. In some examples, the one or more occasions may be in addition to other S-SSB occasions previously configured or indicated to the first UE 115. In some cases, however, the one or more additional occasions may introduce some inefficiency or scheduling uncertainty at the network entity 105 and the first UE 115. For example, if the one or more occasions are not added to a resource pool of the first UE 115 associated with sidelink data transmissions, the first UE 115 may not use resources with the one or more occasions for sidelink data transmissions, which may result in less efficient use of the communication spectrum by the first UE 115. If the one or more occasions are added to the resource pool, however, there may be overlaps (e.g., in time, in frequency, or both) between S-SSB transmissions and sidelink data transmissions (e.g., PSSCH messages) that may be scheduled by the network entity 105 during the one or more occasions. As such, techniques for performing scheduling while resolving or avoiding these overlaps may be desired.

In accordance with examples as described herein, the first UE 115 may transmit a message including an indication to override a default state associated with whether one or more occasions associated with S-SSB transmissions are available for sidelink data transmissions. For example, a default state may be defined (e.g., based on a success rate of LBT procedures at the first UE 115) that indicates whether the one or more occasions associated with S-SSB may be used for sidelink data transmissions. For example, the default state may correspond to the one or more occasions not being used for sidelink transmissions, and the first UE 115 may transmit a message including an indication to override the default state if the first UE 115 is to transmit a sidelink data transmission on an upcoming occasion. Alternatively, the default state may correspond to sidelink data transmissions being allowed during the one or more occasions, and the first UE 115 may transmit a message including an indication to override the default state if the first UE 115 is to transmit an S-SSB 220 on an upcoming occasion. In some cases, the default state may be overridden for the next occasion only, or for all occasions within an S-SSB period until a message including second indication is transmitted to revert to the default state.

Additionally, or alternatively, the first UE 115 may be configured to drop a sidelink data transmission if a priority value associated with the sidelink data transmission is below a priority value associated with an overlapping S-SSB transmission. In these examples, the first UE 115 may transmit a NACK to a network entity 105 with a priority value equal to that of the dropped sidelink data transmission. Accordingly, the network entity may be aware of the dropped sidelink data transmission and performing scheduling accordingly.

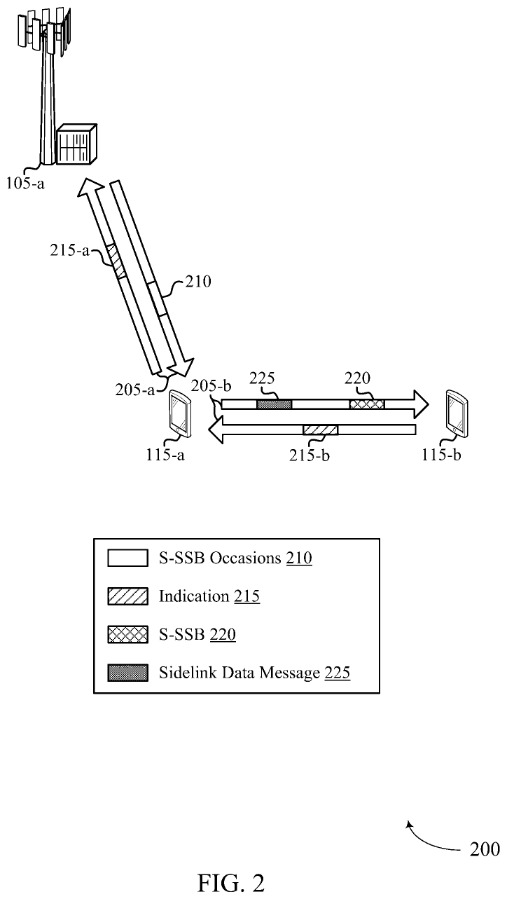

FIG. 2 shows an example of a wireless communications system 200 that supports data transmission availability in S-SSB occasions in accordance with one or more aspects of the present disclosure. The wireless communications system 200 may be an example or incorporate aspects of the wireless communications system 100. For example, the wireless communications system 200 illustrates communications between a UE 115-a, a UE 115-b, and a network entity 105-a, which may be examples of corresponding components described herein, with reference to FIG. 1. Similarly, the UE 115-a, the UE 115-b, and the network entity 105-a may perform communications via communication links 205-a and communication links 205-b, which may be examples of communication links 125 as described herein, with reference to FIG. 1

In some examples, the network entity 105-a may transmit one or more messages 210 (e.g., an RRC message) to configure the UE 115-a with a set of (e.g., one or more) S-SSB occasions associated with transmissions of S-SSBs 220 by the UE 115-a to the UE 115-b. In some examples, the S-SSB occasions may be in addition to other S-SSB occasions previously configured (e.g., preconfigured) or indicated to the UE 115-a (e.g., by the network entity 105-a). In some cases, however, the S-SSB occasions may introduce some inefficiency or scheduling uncertainty at the network entity 105-a and the UE 115-a. For example, if the S-SSB occasions are not included (e.g., added by the network entity 105-a) in a resource pool for sidelink data transmissions by the UE 115-a, the UE 115-a may experience a relatively inefficient use of a communication spectrum, as resources associated with the S-SSB occasions would not be used for sidelink data transmissions by the UE 115-a. However, if the S-SSB occasions are included in the resource pool of the UE 115-a for sidelink data transmissions, the network entity 105-a may schedule sidelink data messages 225 (e.g., PSSCH messages) during these occasions, which may result in overlaps between transmission of an S-SSB 220 (e.g., transmission or broadcast of one or more reference signals) and the sidelink data messages 225. As such, techniques for resolving or avoiding these overlaps may be desired.

In accordance with examples as described herein, the UE 115-a may transmit a message to the network entity 105 that includes an indication 215-a associated with a default state override. The indication 215-a may notify the network entity 105 of an override for a default state associated with whether the S-SSB occasions are available for scheduling by the network entity 105-a of sidelink data transmissions by the UE 115-a. For example, the default state may correspond to the S-SSB occasions being available for sidelink data transmissions. As such, if the UE 115-a has data (e.g., in a buffer) available for a sidelink data message 225, the UE 115-a may transmit the sidelink data message during an occasion of the S-SSB occasions. Meanwhile, the UE 115-a may transmit a message including an indication 215 if the UE 115-a is to transmit an S-SSB 220 to prevent the network entity 105-a from scheduling overlapping sidelink data messages 225 during one or more upcoming occasions of the S-SSB occasions. In some other examples, the default state may correspond to the S-SSB occasions not being available for sidelink data transmissions. As such, the UE 115-a may transmit a message including an indication 215 if the UE 115-a has data (e.g., in a buffer) available for a sidelink data message 225.

In some examples, the default sate may be configured (e.g., or preconfigured) to the UE 115-a, the network entity 105-a, or both. In some cases, the default state may be defined and configured to all UEs 115 in communication with the network entity 105-a. Additionally, or alternatively, the default state may be defined on a per-UE basis, and, in some examples, the default state may be defined by the UE 115-a. For example, the UE 115-a may determine a default state and indicate the default state to the network entity 105-a in a message (e.g., an RRC message). Further, in some cases, there may not be a default state explicitly defined at the UE 115-a or the network entity 105-a, and the UE 115-a may simply indicate an interpretation for the indication 215 (e.g., and future indications 215) transmitted to the network entity 105-a. For example, the UE 115-a may indicate (e.g., in an RRC message) whether an indication 215 corresponds to enabling S-SSB occasions for sidelink data transmissions or disabling S-SSB occasions for sidelink data transmissions, without explicitly defining a default state.

In some examples, the default state may be based on one or more conditions at the UE 115-a, such as a success rate of LBT procedures at the UE 115-a. For example, the UE 115-a may perform LBT procedures prior to performing an S-SSB 220 transmission. The UE 115-a may listen (e.g., sense) for transmission by other devices prior to the broadcasting the S-SSB 220 and may perform the broadcast if the UE 115-a determines that there are no transmissions by other devices (e.g., or a measured signal strength is below a threshold value). In some examples, if a success rate of LBT procedures (e.g., rate of LBT procedures resulting in transmissions by the UE 115-a) at the UE 115-a is high, the default state may correspond to the S-SSB occasions being available for sidelink data transmissions. Alternatively, if the success rate of LBT procedures at the UE 115-a is low, which may correspond to a relatively busy transmission environment, the default state may correspond to the S-SSB occasions not being available for sidelink data transmissions.

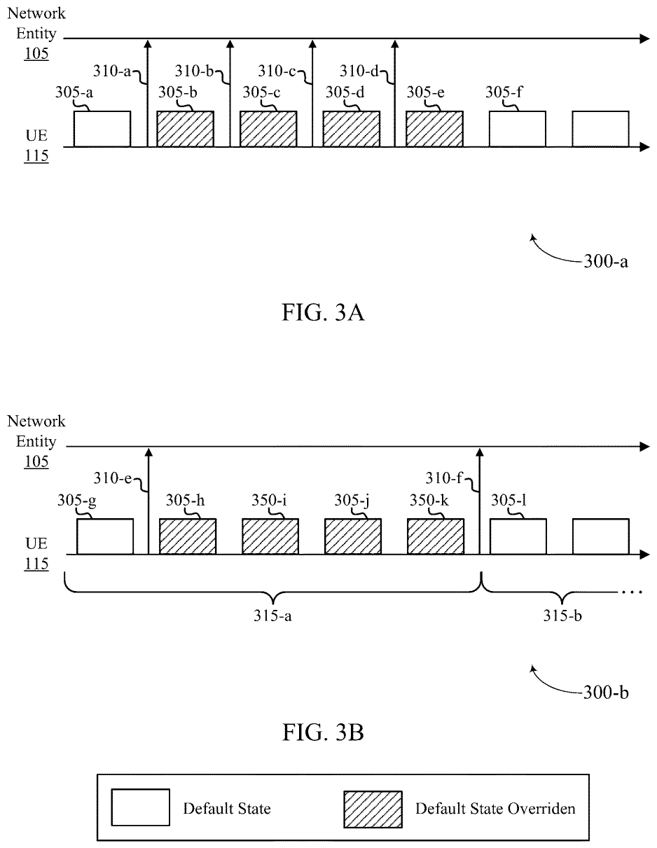

In some examples, an indication 215 may indicate that the default state is overridden (e.g., or that S-SSB occasions are enabled or disabled for sidelink data transmissions) for a single upcoming S-SSB occasion. For example, the indication 215 may apply (e.g., correspond) to a next S-SSB occasion of the S-SSB occasions, or to a specific S-SSB occasion of the S-SSB occasions that is indicated in a message (e.g., the message containing the indication 215). In some other examples, an indication 215 may apply to all upcoming occasions of the S-SSB occasions until the UE 115-a transmits a second message containing a second indication 215, in which case the default state is restored (e.g., S-SSB occasions are disabled or enabled for sidelink data transmissions, corresponding to the state before transmission of the first indication 215). In some cases, the indication 215 may expire based on the expiration of a current S-SSB period, and the default state may be restored based on the beginning of a new S-SSB period regardless of the network entity 105-a having received a second indication 215 from the UE 115-a. These examples are described in more detail herein, with reference to FIGS. 3A and 3B.

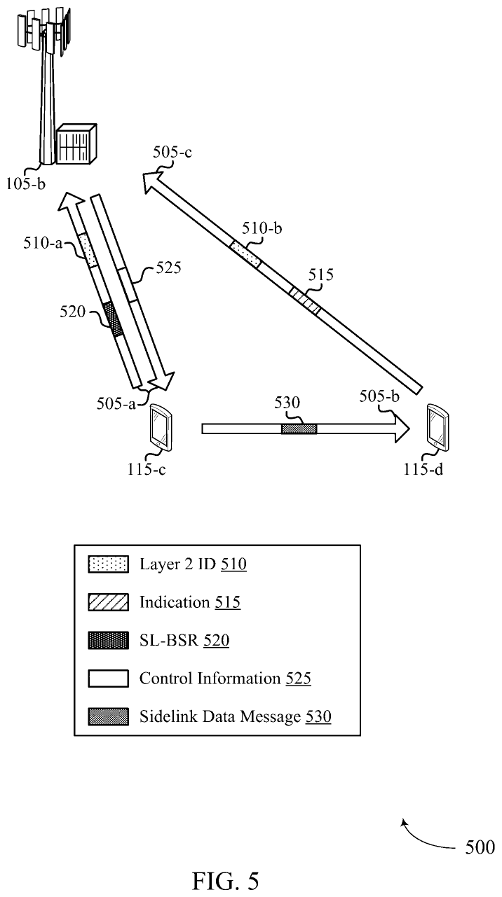

In some cases, the UE 115-b may transmit a message containing an indication 215-b associated with overriding the default state to the UE 115-a, and the UE 115-a may forward the indication 215-b by transmitting the message containing the indication 215-a to the network entity 105-a. For example, the UE 115-b may be unable to communicate with the network entity 105-a, or the network entity 105-a may not be aware of which UE 115 the UE 115-a is performing sidelink communications with, as sidelink destination IDs indicated by the UE 115-a (e.g., within a SL-BSR) may be relative in nature, and not identify the UE 115-b without additional information. In some cases, the UE 115-b may determine to transmit the indication 215-b based on similarly to the UE 115-a. For example, if the default state corresponds to the S-SSB occasions being available for sidelink data transmissions, the UE 115-b may transmit a message including the indication 215-b if the UE 115-b is to transmit (e.g., or receive) reference signals associated with an S-SSB 220 to prevent the network entity 105-a from scheduling overlapping sidelink data transmissions during one or more upcoming occasions of the S-SSB occasions. Meanwhile, if the default state corresponds to the S-SSB occasions not being available for sidelink data transmissions, the UE 115-b may transmit a message including the indication 215-b if the UE 115-b has data (e.g., in a buffer) available for a sidelink data message 225 (e.g., or if the UE 115-b is awaiting to receive a sidelink data message 225 from the UE 115-a). Alternatively, the UE 115-b may directly transmit a message containing the indication 215-b to the network entity 105-a, as described with more detail herein with reference to FIG. 5.

FIG. 3A shows an example of a signaling diagram 300-a that supports data transmission availability in S-SSB occasions in accordance with one or more aspects of the present disclosure. The signaling diagram 300-a may depict S-SSB occasions 305 (e.g., an S-SSB occasion 305-a, an S-SSB occasion 305-b, an S-SSB occasion 305-c, an S-SSB occasion 305-d, and an S-SSB occasion 305-e), which may be associated with an occasion (e.g., one or more resources) during which an S-SSB (e.g., one or more S-SSB reference signals) may be transmitted (e.g., broadcast) by a UE 115, as described herein with reference to FIGS. 1 and 2. Further, the signaling diagram 300-a illustrates example communications of indications 310 (e.g., an indication 310-a, an indication 310-b, an indication 310-c, and an indication 310-d) between the UE 115 and a network entity 105, which may be examples of an indication 215 associated with whether S-SSB occasions 305 are enabled or disabled for sidelink data transmissions (e.g., by indicating an override of a default state), as described herein with reference to FIG. 2.

In some examples, the S-SSB occasions 305 may be associated with a default state, as described herein with reference to FIGS. 1 and 2. For example, the default state may correspond to the S-SSB occasions 305 being available for sidelink data transmissions. As such, the UE 115 may transmit a message including an indication 310 if the UE 115 is to transmit an S-SSB (e.g., one or more S-SSB reference signals) to prevent the network entity 105 from scheduling overlapping sidelink data messages during one or more upcoming S-SSB occasions 305. In some other examples, the default state may correspond to the S-SSB occasions 305 not being available for sidelink data transmissions. As such, the UE 115 may transmit a message including an indication 310 if the UE 115 has data (e.g., in a sidelink data buffer) available for a sidelink data transmission.

In some examples, an indication 310 may indicate that the default state is overridden (e.g., or that S-SSB occasions 305 are enabled or disabled for sidelink data transmissions, for example, in case a default state is not explicitly defined) for a single upcoming S-SSB occasion 305. For example, as illustrated in FIG. 3A, the indication 310-a may indicate that the default state is overridden for a next S-SSB occasion 305-b. Similarly, the UE 115 may transmit, to the network entity 105, an indication 310-b to indicate that the default state is overridden for the S-SSB occasion 305-c, an indication 310-c to indicate that the default state is overridden for the S-SSB occasion 305-d, and an indication 310-d to indicate that the default state is overridden for the S-SSB occasion 305-e. The UE 115 may not transmit an indication following the S-SSB occasion 305-e and prior to a next S-SSB occasion 305-f and, as such, the default state may apply again for the S-SSB occasion 305-f.

FIG. 3B shows an example of a signaling diagram 300-b that supports data transmission availability in S-SSB occasions in accordance with one or more aspects of the present disclosure. The signaling diagram 300-b may implement aspects of the signaling diagram 300-a. For example, the signaling diagram 300-b may depict S-SSB occasions 305 (e.g., an S-SSB occasion 305-g, an S-SSB occasion 305-h, an S-SSB occasion 305-i, an S-SSB occasion 305-j, an S-SSB occasion 305-k, and an S-SSB occasion 305-1), which may be examples of S-SSB occasions as described with reference to FIGS. 1 through 3A. Further, the signaling diagram 300-b illustrates example communications of indications 310 (e.g., an indication 310-e and an indication 310-f) between the UE 115 and a network entity 105, which may be examples of an indication 215 or an indication 310 associated with whether S-SSB occasions 305 are enabled or disabled for sidelink data transmissions, as described with reference to FIGS. 2 and 3A.

In some examples, an indication 310 may indicate that the default state is overridden (e.g., or that S-SSB occasions 305 are enabled or disabled for sidelink data transmissions, for example, in case a default state is not explicitly defined) for all upcoming S-SSB occasions 305 until a second indication 310 is transmitted by the UE 115 (e.g., or, in some cases, another UE 115 in communication with the UE 115) to the network entity 105. For example, the default state may apply to the S-SSB occasion 305-g. The UE 115 may then transmit an indication 310-e, which may override the default state for subsequent S-SSB occasions 305. For example, the default state may be overridden for the S-SSB occasion 305-h, the S-SSB occasion 305-i, the S-SSB occasion 305-j, and the S-SSB occasion 305-k. The UE 115 may then transmit another indication 310-f, which may reinstate the default state for subsequent S-SSB occasions 305, such as the S-SSB occasion 305-1.

In some cases, an indication 310 may expire based on the expiration of a current S-SSB period 315. For example, a first S-SSB period 315-a may end prior to the start of the S-SSB occasion 305-1 and subsequent to the S-SSB occasion 305-k. As such, the default state may be restored for subsequent S-SSB occasions 305 (e.g., beginning with the S-SSB occasion 305-1) within a second S-SSB period 315-b, even if the UE 115 did not transmit the indication 310-f to the network entity 105.

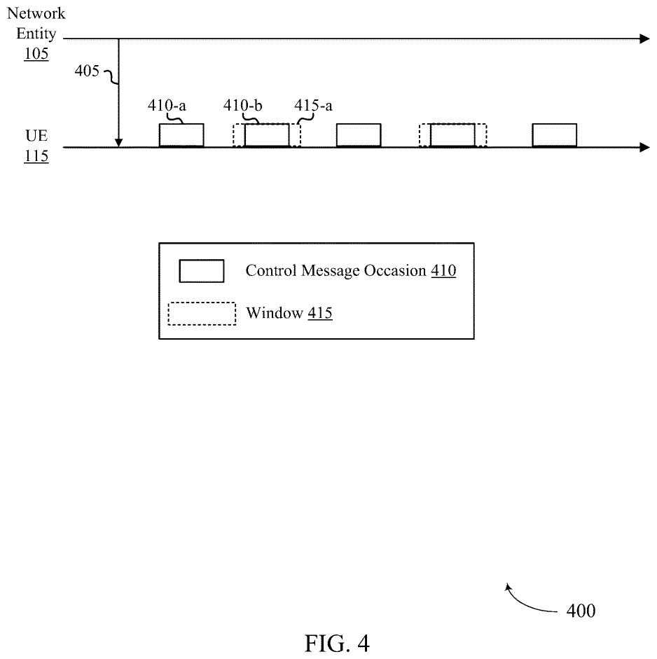

FIG. 4 shows an example of a signaling diagram 400 that supports data transmission availability in S-SSB occasions in accordance with one or more aspects of the present disclosure. The signaling diagram 400 may illustrates communications between a UE 115 and a network entity 105, which may be examples of corresponding components as described herein, with reference to FIGS. 1 through 3B.

In some examples, the UE 115 may transmit an indication to indicate that a default state is overridden (e.g., or that S-SSB occasions are enabled or disabled for sidelink data transmissions, for example, in case a default state is not explicitly defined) for one or more S-SSB occasions, as described herein with reference to FIGS. 1 through 3B. In some cases, the indication may be transmitted by the UE 115 within a control message (e.g., a PUCCH) to the network entity 105, and one or more control message occasions 410 may be configured to the UE 115 via an RRC message (e.g., within one or more information elements, such as PUCCH-Config). For example, the UE 115 may transmit a dedicated control message (e.g., a control message generated for transmission of the indication) that includes the indication associated with the default state override to the network entity 105 during a control message occasion 410-a.

Additionally, or alternatively, the UE 115 may include the indication within a control message carrying other control information as one or more additional bits (e.g., multiplexed or piggybacked to the control message). In some examples, the network entity 105 may transmit a downlink message 405 (e.g., a control message, an RRC message containing one or more information elements) that may configure the UE 115 with one or more windows 415 (e.g., including one or more time resources, frequency resources, or both) for transmission of a control message. In some cases, a control message transmitted during a control message occasion 410 within a configured window 415 may be larger (e.g., have a larger payload size) than control messages transmitted outside a configured window 415, as the configured window 415 may allocate more resources for transmission of additional information. As such, the UE 115 may be configured to transmit the indication as one or more additional bits within control messages transmitted during a configured window 415. For example, the UE 115 may include the indication as one or more additional bits included (e.g., multiplexed, piggybacked) in a control message including other control information and transmitted during a control message occasion 410-b within a configured window 415-a.

FIG. 5 shows an example of a wireless communications system 500 that supports data transmission availability in S-SSB occasions in accordance with one or more aspects of the present disclosure. The wireless communications system 500 may be an example or incorporate aspects of the wireless communications system 100 and the wireless communications system 200. For example, the wireless communications system 500 illustrates communications between a UE 115-c, a UE 115-d, and a network entity 105-b, which may be examples of corresponding components described herein, with reference to FIGS. 1 through 4. Similarly, the UE 115-c, the UE 115-d, and the network entity 105-n may perform communications via communication links 505-a, communication links 505-b, and communication links 505-c, which may be examples of communication links 125 or communication links 205 as described herein, with reference to FIGS. 1 and 2.

In some examples, the UE 115-c and the UE 115-d may transmit a message to the network entity 105-b containing an indication 515 associated with overriding a default state associated with one or more S-SSB occasions, as described herein with reference to FIGS. 2 through 4. In some cases, however, the network entity 105-b may not be aware of which UEs 115 the UE 115-a is performing sidelink communications with. For example, the UE 115-a may transmit a SL-BSR 520, which may include one or more sidelink destination IDs. However, the network entity 105-b may not be able to determine which UEs 115 the sidelink destination IDs correspond to. As such, if the UE 115-d transmits a message including an indication 515 to the network entity 105-b, the network entity 105-b may not be able to associate the indication 515 with sidelink communications for the UE 115-c. This may lead to scheduling uncertainty, as the network entity 105-b may not be able to correctly enable or disable sidelink data messages 530 from being communicated during S-SSB occasions if indicated by the UE 115-d.

In accordance with examples as described herein, the UE 115-c and the UE 115-d may be configured to transmit one or more respective Layer 2 IDs 510 to the network entity 105-b. For example, the UE 115-c may transmit a message (e.g., an RRC message) indicating one or more Layer 2 IDs 510-a associated with the UE 115-c to the network entity 105-b, and the UE 115-d may transmit a message (e.g., an RRC message) indicating one or more Layer 2 IDs 510-b associated with the UE 115-d to the network entity 105-b. In some cases, the one or more Layer 2 IDs 510 may be associated with different cast types, different sessions, or both. In some examples, a message indicating the Layer 2 IDs 510 may be transmitted during communication set up procedures, such as when the UE 115-c and the UE 115-d initiate sidelink procedures.

Accordingly, the network entity 105-b may receive a SL-SBR 520 from the UE 115-c, and the network entity 105-b may identify (e.g., determine) UEs 115 in communication with the UE 115-c based on destination IDs provided in the SL-SBR 520 (e.g., associated with the UE 115-d and, in some cases, other UEs 115) and any reported Layer 2 IDs 510. For example, the network entity 105-b may determine that the UE 115-d is in sidelink communication with the UE 115-c based on the destination IDs provided in the SL-SBR 520 by the UE 115-c and the one or more Layer 2 IDs 510-b provided by the UE 115-d. In some examples, the network entity 105-b may generate a mapping between received Layer 2 IDs 510 and UEs 115 based on received Layer 2 IDs 510. Further, the network entity 105-b may identify that the UE 115-d has transmitted the indication 515, and the network entity 105-b may associate the indication 515 with scheduling for the UE 115-c based on the mapping and the SL-SBR 520. As such, the network entity 105-b may perform scheduling of sidelink data messages 530 by the UE 115-c while preventing overlaps with S-SSB transmissions, for example, by enabling or disabling transmissions of the sidelink data messages 530 during S-SSB occasions based on the indication 515 received from the UE 115-d (e.g., with respect to a default state override, as described herein).

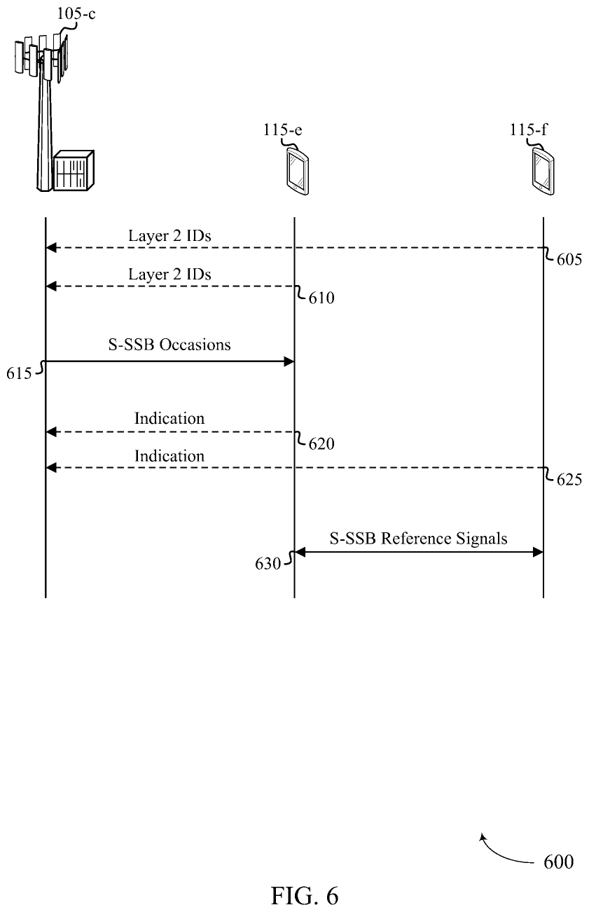

FIG. 6 shows an example of a process flow 600 that supports data transmission availability in S-SSB occasions in accordance with one or more aspects of the present disclosure. The process flow 600 may illustrates communications between a network entity 105-c, a UE 115-e, and a UE 115-f, which may be examples of corresponding devices as described herein, with reference to FIGS. 1 through 5. In some examples, the steps depicted in the process flow 600 may be performed in different orders. Additionally, some steps may be added or omitted from the process flow 600.

At 605, the UE 115-f may transmit a message (e.g., an RRC message) indicating one or more Layer 2 IDs associated with the UE 115-f to the network entity 105-c. Similarly, at 610, the UE 115-e may transmit a message (e.g., an RRC message) indicating one or more Layer 2 IDs 510-a associated with the UE 115-e to the network entity 105-c. In some examples, the Layer 2 IDs may enable the network entity 105-c to map the Layer 2 IDs to a respective UE 115.

At 615, the network entity 105-c may transmit a message (e.g., an RRC message) to configure the UE 115-e with one or more S-SSB occasions associated with transmissions (e.g., broadcasts) of S-SSBs by the UE 115-e. In some examples, the one or more S-SSB occasions may be in addition to other S-SSB occasions previously configured or indicated to the UE 115-e (e.g., by the network entity 105-c).

At 620, the UE 115-e may transmit a message including an indication associated with a default state override. The indication may notify the network entity 105-c of an override for a default state associated with whether the one or more S-SSB occasions are available for scheduling by the network entity 105-c of sidelink data transmissions associated with the UE 115-e. For example, the default state may correspond to the one or more S-SSB occasions being available for sidelink data transmissions. As such, the UE 115-e may transmit a message including an indication if the UE 115-e is to transmit an S-SSB (e.g., one or more S-SSB reference signals) to prevent the network entity 105-c from scheduling overlapping sidelink data messages during one or more upcoming occasions of the S-SSB occasions. In some other examples, the default state may correspond to the S-SSB occasions not being available for sidelink data transmissions. As such, the UE 115-e may transmit a message including an indication if the UE 115-e has data (e.g., in a sidelink data buffer) available for a sidelink data message.

At 625, the UE 115-f may transmit a message including the indication. For example, the network entity 105-c may identify that the UE 115-e and the UE 115-f are in sidelink communications based on receiver Layer 2 IDs and an SL-BSR transmitted by the UE 115-e. As such, the network entity 105-c may perform scheduling of sidelink data transmissions for the UE 115-e based on the indication transmitted by the UE 115-f.

At 630, the UE 115-e and the UE 115-f may communicate one or more S-SSB reference signals (e.g., one or more reference signals associated with an S-SSB broadcast) in accordance with scheduling by the network entity 105-c. For example, the UE 115-e may broadcast one or more S-SSB reference signals, and the UE 115-f may measure the one or more S-SSB reference signals. Additionally, or alternatively, the UE 115-f may broadcast one or more S-SSB reference signals, and the UE 115-e may receive the one or more S-SSB reference signals.

Accordingly, by transmitting an indication associated with overriding a default state, the UE 115-e and the UE 115-f may communicate sidelink data messages and S-SSB reference signals without overlapping during S-SSB occasions.

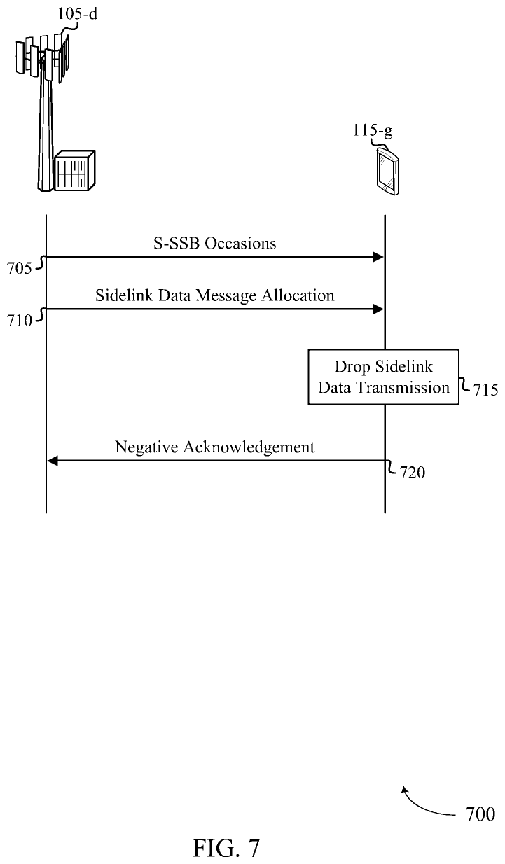

FIG. 7 shows an example of a process flow 700 that supports data transmission availability in S-SSB occasions in accordance with one or more aspects of the present disclosure. The process flow 700 may illustrates communications between a network entity 105-d, and a UE 115-g, which may be examples of corresponding devices as described herein, with reference to FIGS. 1 through 6. In some examples, the steps depicted in the process flow 700 may be performed in different orders. Additionally, some steps may be added or omitted from the process flow 700.

At 705, the network entity 105-d may transmit a message (e.g., an RRC message) to configure the UE 115-g with one or more S-SSB occasions associated with transmissions (e.g., broadcasts) of S-SSBs by the UE 115-g. In some examples, the one or more S-SSB occasions may be in addition to other S-SSB occasions previously configured or indicated to the UE 115-g (e.g., by the network entity 105-d).

At 710, the network entity 105-d may transmit a message that allocates the UE 115-g with one or more resources for a sidelink data message (e.g., a PSSCH) with another UE 115. In some examples, the one or more resources for the sidelink data message may overlap with an occasion of the one or more S-SSB occasions.

At 715, the UE 115-g may determine that the sidelink data message overlaps with an S-SSB to be transmitted on an occasion of the one or more S-SSB occasions, and the UE 115-g may drop the sidelink data message. In some examples, the UE 115-g may drop the sidelink data message based on a priority value of the sidelink data message being lower than a priority value associated with an S-SSB to be transmitted within the overlapping occasion.

At 720, the UE 115-g may transmit a negative acknowledgment (e.g., a NACK) within a control message (e.g., a PUCCH) associated with the sidelink data message (e.g., a PUCCH for signaling HARQ-ACK associated with the sidelink data message). In some examples, the negative acknowledgment (e.g., or the PUCCH carrying the negative acknowledgment) may have a same priority value as the priority value of the dropped sidelink data message.

Accordingly, the UE 115-g may utilize S-SSB occasions for transmitting sidelink data messages, and the UE 115-g may be configured with a procedure to notify the network entity 105-d in case of an overlap between the sidelink data messages and an S-SSB. As such, the network entity 105-d may perform rescheduling of dropped sidelink data messages, and may configure the UE 115-g with an additional grant for a sidelink data message.

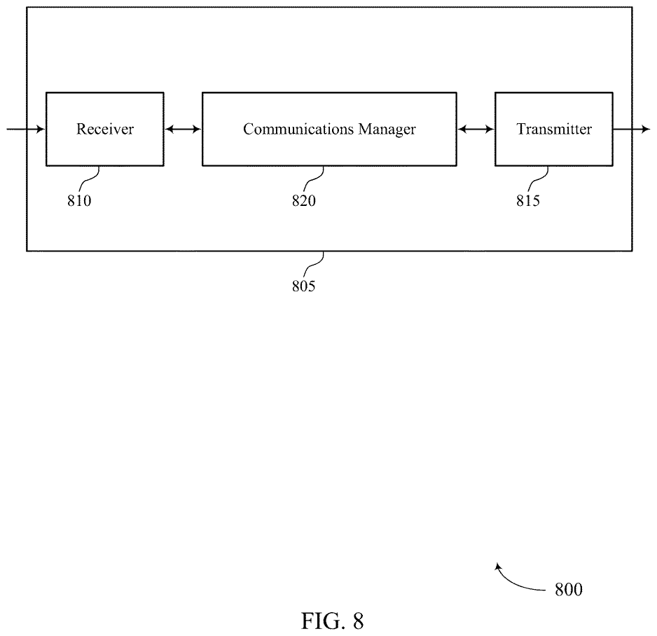

FIG. 8 shows a block diagram 800 of a device 805 that supports data transmission availability in S-SSB occasions in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to data transmission availability in S-SSB occasions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to data transmission availability in S-SSB occasions). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of data transmission availability in S-SSB occasions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE in accordance with examples as disclosed herein. For example, the communications manager 820 is capable of, configured to, or operable to support a means for receiving a first message indicating one or more occasions associated with S-SSB transmissions between at least the first UE and a second UE. The communications manager 820 is capable of, configured to, or operable to support a means for transmitting, to a network entity, a second message that includes an indication to override a default state, the default state associated with whether the one or more occasions are available for sidelink data transmissions between at least the first UE and the second UE. The communications manager 820 is capable of, configured to, or operable to support a means for communicating one or more reference signals between at least the first UE and the second UE based on transmitting the second message to the network entity.

Additionally, or alternatively, the communications manager 820 may support wireless communication at a first UE in accordance with examples as disclosed herein. For example, the communications manager 820 is capable of, configured to, or operable to support a means for receiving a message indicating one or more occasions associated with S-SSB transmissions between at least the first UE and a second UE, where an upcoming occasion of the one or more occasions associated with S-SSB transmissions overlaps with an occasion for a sidelink data transmission. The communications manager 820 is capable of, configured to, or operable to support a means for dropping the sidelink data transmission based on a priority value associated with the sidelink data transmission being lower than a priority value associated with a synchronization signal block transmission associated with the upcoming occasion. The communications manager 820 is capable of, configured to, or operable to support a means for transmitting a negative acknowledgment message based on dropping the sidelink data transmission, where a priority value of the negative acknowledgment message is a same value as the priority value of the sidelink data transmission.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for performing sidelink data transmissions in a larger communication spectrum while avoiding overlap with S-SSB transmissions, leading to more efficient utilization of communication resources.

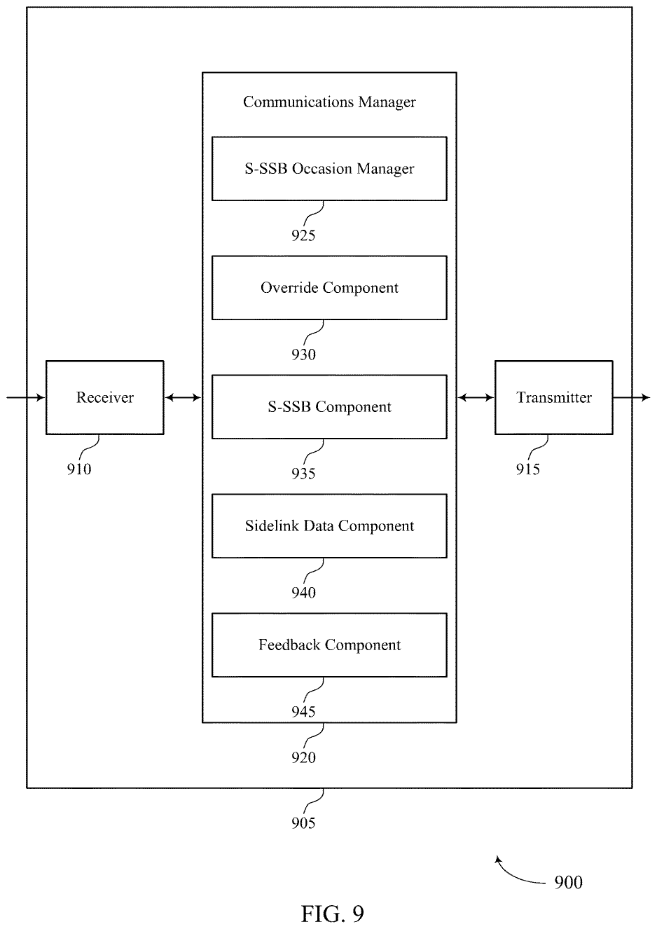

FIG. 9 shows a block diagram 900 of a device 905 that supports data transmission availability in S-SSB occasions in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to data transmission availability in S-SSB occasions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to data transmission availability in S-SSB occasions). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of data transmission availability in S-SSB occasions as described herein. For example, the communications manager 920 may include an S-SSB occasion manager 925, an override component 930, an S-SSB component 935, a sidelink data component 940, a feedback component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first UE in accordance with examples as disclosed herein. The S-SSB occasion manager 925 is capable of, configured to, or operable to support a means for receiving a first message indicating one or more occasions associated with S-SSB transmissions between at least the first UE and a second UE. The override component 930 is capable of, configured to, or operable to support a means for transmitting, to a network entity, a second message that includes an indication to override a default state, the default state associated with whether the one or more occasions are available for sidelink data transmissions between at least the first UE and the second UE. The S-SSB component 935 is capable of, configured to, or operable to support a means for communicating one or more reference signals between at least the first UE and the second UE based on transmitting the second message to the network entity.

Additionally, or alternatively, the communications manager 920 may support wireless communication at a first UE in accordance with examples as disclosed herein. The S-SSB component 935 is capable of, configured to, or operable to support a means for receiving a message indicating one or more occasions associated with S-SSB transmissions between at least the first UE and a second UE, where an upcoming occasion of the one or more occasions associated with S-SSB transmissions overlaps with an occasion for a sidelink data transmission. The sidelink data component 940 is capable of, configured to, or operable to support a means for dropping the sidelink data transmission based on a priority value associated with the sidelink data transmission being lower than a priority value associated with a synchronization signal block transmission associated with the upcoming occasion. The feedback component 945 is capable of, configured to, or operable to support a means for transmitting a negative acknowledgment message based on dropping the sidelink data transmission, where a priority value of the negative acknowledgment message is a same value as the priority value of the sidelink data transmission.

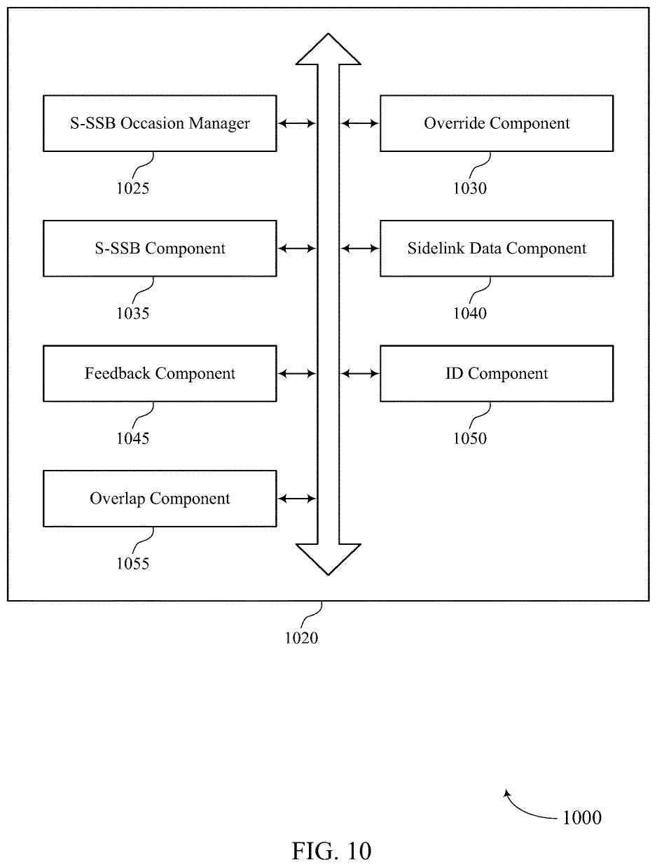

FIG. 10 shows a block diagram 1000 of a communications manager 1020 that supports data transmission availability in S-SSB occasions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of data transmission availability in S-SSB occasions as described herein. For example, the communications manager 1020 may include an S-SSB occasion manager 1025, an override component 1030, an S-SSB component 1035, a sidelink data component 1040, a feedback component 1045, an ID component 1050, an overlap component 1055, or any combination thereof. Each of these components may communicate, directly or indirectly, with one another (e.g., via one or more buses).

The communications manager 1020 may support wireless communication at a first UE in accordance with examples as disclosed herein. The S-SSB occasion manager 1025 is capable of, configured to, or operable to support a means for receiving a first message indicating one or more occasions associated with S-SSB transmissions between at least the first UE and a second UE. The override component 1030 is capable of, configured to, or operable to support a means for transmitting, to a network entity, a second message that includes an indication to override a default state, the default state associated with whether the one or more occasions are available for sidelink data transmissions between at least the first UE and the second UE. The S-SSB component 1035 is capable of, configured to, or operable to support a means for communicating one or more reference signals between at least the first UE and the second UE based on transmitting the second message to the network entity.

In some examples, the second message indicates that the default state is overridden for a next occasion of the one or more occasions. In some examples, the second message indicates that the default state is overridden for occasions within a current S-SSB period.

In some examples, the override component 1030 is capable of, configured to, or operable to support a means for transmitting, to the network entity, a fourth message that includes an indication to return to the default state for occasions within the current S-SSB period.

In some examples, the ID component 1050 is capable of, configured to, or operable to support a means for transmitting, to the network entity and prior to receiving the first message, a third message indicating one or more Layer 2 ID values associated with the first UE.

In some examples, the default state indicates that the one or more occasions are available for sidelink data transmissions between at least the first UE and the second UE. In some examples, the default state indicates that the one or more occasions are not available for sidelink data transmissions between at least the first UE and the second UE.

In some examples, the sidelink data component 1040 is capable of, configured to, or operable to support a means for transmitting, based on the default state being overridden, a sidelink data message to the second UE during a next occasion of the one or more occasions.

In some examples, to support communicating the one or more reference signals, the S-SSB component 1035 is capable of, configured to, or operable to support a means for communicating the one or more reference signals during an occasion that follows the next occasion of the one or more occasions.

In some examples, the override component 1030 is capable of, configured to, or operable to support a means for transmitting, to the network entity, a fourth message that includes an indication to return to the default state for occasions within a current S-SSB period, where communicating the one or more reference signals is based on transmitting the fourth message.

In some examples, the default state is based on a success rate associated with listen-before-talk procedures for S-SSB transmissions at the first UE. In some examples, the indication to override the default state includes one or more bits within the second message, the second message including an uplink control message.

In some examples, to support transmitting the second message, the override component 1030 is capable of, configured to, or operable to support a means for transmitting the uplink control message during a time window configured by the network entity, where the one or more bits include one or more additional bits included in the second message based on transmitting the uplink control message during the time window. In some examples, the second message includes a dedicated control message associated with transmitting the indication to override the default state.

In some examples, the override component 1030 is capable of, configured to, or operable to support a means for receiving, from the second UE, a message that includes the indication to override the default state, where transmitting the second message to the network entity is based on receiving the message that includes the indication to override the default state from the second UE.

In some examples, the overlap component 1055 is capable of, configured to, or operable to support a means for determining that an upcoming occasion of the one or more occasions associated with S-SSB transmissions overlaps with an occasion for a sidelink data transmission. In some examples, the sidelink data component 1040 is capable of, configured to, or operable to support a means for dropping the sidelink data transmission based on a priority value associated with the sidelink data transmission being lower than a priority value associated with a S-SSB transmission associated with the upcoming occasion. In some examples, the feedback component 1045 is capable of, configured to, or operable to support a means for transmitting a negative acknowledgment message based on dropping the sidelink data transmission, where a priority value associated with the negative acknowledgment message is a same value as the priority value associated with the sidelink data transmission.

Additionally, or alternatively, the communications manager 1020 may support wireless communication at a first UE in accordance with examples as disclosed herein. In some examples, the S-SSB component 1035 is capable of, configured to, or operable to support a means for receiving a message indicating one or more occasions associated with S-SSB transmissions between at least the first UE and a second UE, where an upcoming occasion of the one or more occasions associated with S-SSB transmissions overlaps with an occasion for a sidelink data transmission. The sidelink data component 1040 is capable of, configured to, or operable to support a means for dropping the sidelink data transmission based on a priority value associated with the sidelink data transmission being lower than a priority value associated with a synchronization signal block transmission associated with the upcoming occasion. The feedback component 1045 is capable of, configured to, or operable to support a means for transmitting a negative acknowledgment message based on dropping the sidelink data transmission, where a priority value of the negative acknowledgment message is a same value as the priority value of the sidelink data transmission.

In some examples, the S-SSB component 1035 is capable of, configured to, or operable to support a means for transmitting one or more reference signals to the second UE based on dropping the sidelink data transmission.

In some examples, the override component 1030 is capable of, configured to, or operable to support a means for transmitting, to a network entity, a message that includes an indication to override a default state, the default state associated with whether the one or more occasions can be used for sidelink data transmissions between at least the first UE and the second UE.

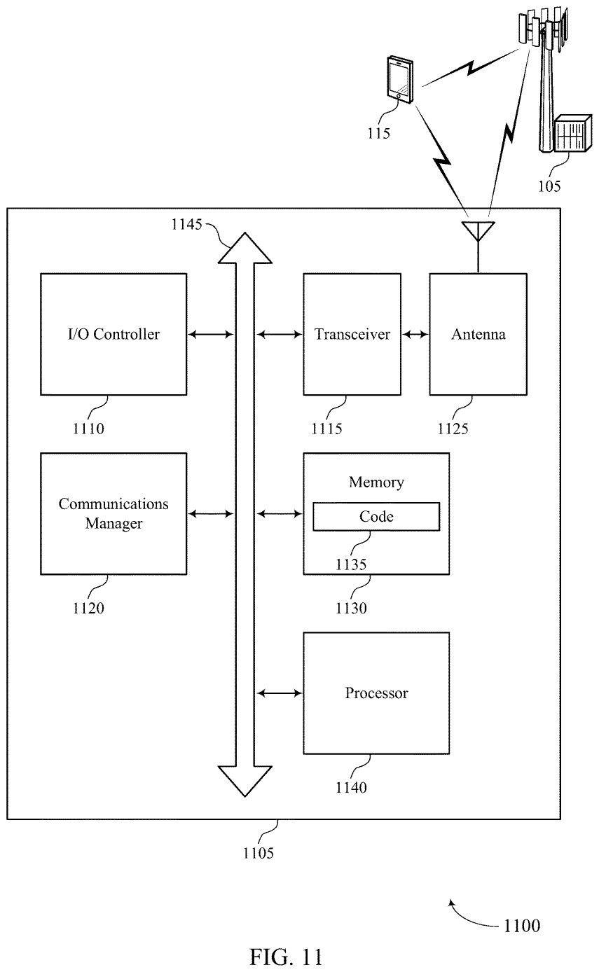

FIG. 11 shows a diagram of a system 1100 including a device 1105 that supports data transmission availability in S-SSB occasions in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting data transmission availability in S-SSB occasions). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a first UE in accordance with examples as disclosed herein. For example, the communications manager 1120 is capable of, configured to, or operable to support a means for receiving a first message indicating one or more occasions associated with S-SSB transmissions between at least the first UE and a second UE. The communications manager 1120 is capable of, configured to, or operable to support a means for transmitting, to a network entity, a second message that includes an indication to override a default state, the default state associated with whether the one or more occasions are available for sidelink data transmissions between at least the first UE and the second UE. The communications manager 1120 is capable of, configured to, or operable to support a means for communicating one or more reference signals between at least the first UE and the second UE based on transmitting the second message to the network entity.

Additionally, or alternatively, the communications manager 1120 may support wireless communication at a first UE in accordance with examples as disclosed herein. For example, the communications manager 1120 is capable of, configured to, or operable to support a means for receiving a message indicating one or more occasions associated with S-SSB transmissions between at least the first UE and a second UE, where an upcoming occasion of the one or more occasions associated with S-SSB transmissions overlaps with an occasion for a sidelink data transmission. The communications manager 1120 is capable of, configured to, or operable to support a means for dropping the sidelink data transmission based on a priority value associated with the sidelink data transmission being lower than a priority value associated with a synchronization signal block transmission associated with the upcoming occasion. The communications manager 1120 is capable of, configured to, or operable to support a means for transmitting a negative acknowledgment message based on dropping the sidelink data transmission, where a priority value of the negative acknowledgment message is a same value as the priority value of the sidelink data transmission.

By including or configuring the communications manager 1120 in accordance with examples as described herein, the device 1105 may support techniques for performing sidelink data transmissions in a larger communication spectrum while avoiding overlap with S-SSB transmissions, leading to more efficient utilization of communication resources and reduced latency due to avoiding retransmissions.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of data transmission availability in S-SSB occasions as described herein, or the processor 1140 and the memory 1130 may be otherwise configured to perform or support such operations.

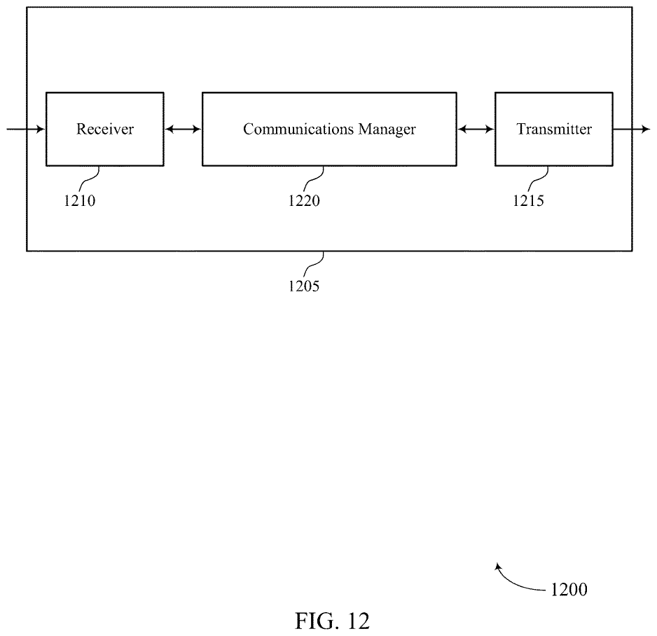

FIG. 12 shows a block diagram 1200 of a device 1205 that supports data transmission availability in S-SSB occasions in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of data transmission availability in S-SSB occasions as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 is capable of, configured to, or operable to support a means for transmitting, to a first UE, a first message indicating one or more occasions associated with S-SSB transmissions between at least the first UE and a second UE. The communications manager 1220 is capable of, configured to, or operable to support a means for receiving a second message that includes an indication to override a default state, the default state associated with whether the one or more occasions are available for sidelink data transmissions between at least the first UE and the second UE. The communications manager 1220 is capable of, configured to, or operable to support a means for scheduling one or more sidelink data transmissions between at least the first UE and the second UE for one or more resources that are selected based on least in part on the default state being overridden.

Additionally, or alternatively, the communications manager 1220 may support wireless communication at a network entity in accordance with examples as disclosed herein. For example, the communications manager 1220 is capable of, configured to, or operable to support a means for transmitting a message indicating one or more occasions associated with S-SSB transmissions between at least a first UE and a second UE, where an upcoming occasion of the one or more occasions associated with S-SSB transmissions overlaps with an occasion for a sidelink data transmission. The communications manager 1220 is capable of, configured to, or operable to support a means for receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for scheduling sidelink data transmissions while avoiding overlap with S-SSB transmissions, leading to more efficient utilization of communication resources.

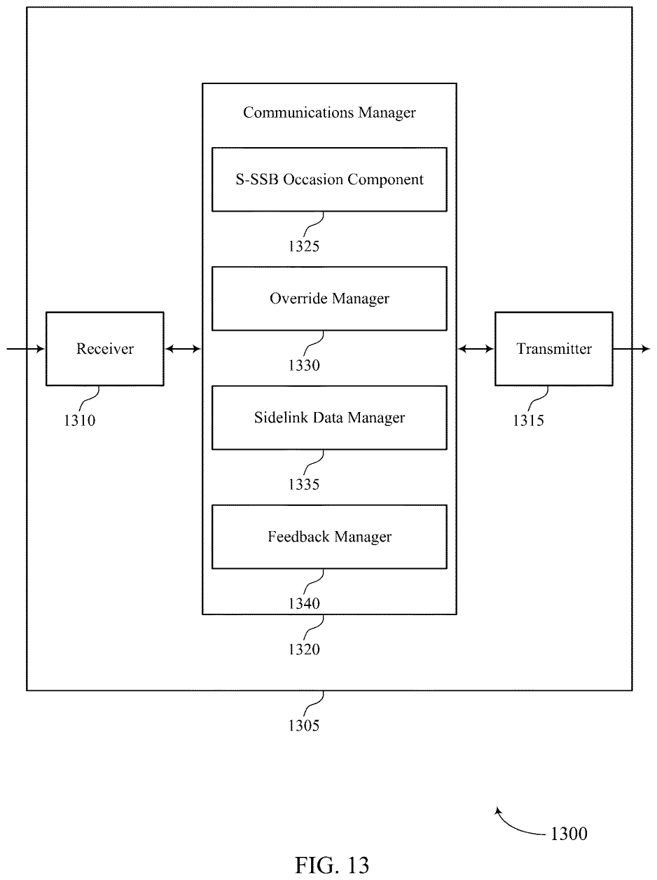

FIG. 13 shows a block diagram 1300 of a device 1305 that supports data transmission availability in S-SSB occasions in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of data transmission availability in S-SSB occasions as described herein. For example, the communications manager 1320 may include an S-SSB occasion component 1325, an override manager 1330, a sidelink data manager 1335, a feedback manager 1340, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The S-SSB occasion component 1325 is capable of, configured to, or operable to support a means for transmitting, to a first UE, a first message indicating one or more occasions associated with S-SSB transmissions between at least the first UE and a second UE. The override manager 1330 is capable of, configured to, or operable to support a means for receiving a second message that includes an indication to override a default state, the default state associated with whether the one or more occasions are available for sidelink data transmissions between at least the first UE and the second UE. The sidelink data manager 1335 is capable of, configured to, or operable to support a means for scheduling one or more sidelink data transmissions between at least the first UE and the second UE for one or more resources that are selected based on least in part on the default state being overridden.

Additionally, or alternatively, the communications manager 1320 may support wireless communication at a network entity in accordance with examples as disclosed herein. The S-SSB occasion component 1325 is capable of, configured to, or operable to support a means for transmitting a message indicating one or more occasions associated with S-SSB transmissions between at least a first UE and a second UE, where an upcoming occasion of the one or more occasions associated with S-SSB transmissions overlaps with an occasion for a sidelink data transmission. The feedback manager 1340 is capable of, configured to, or operable to support a means for receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

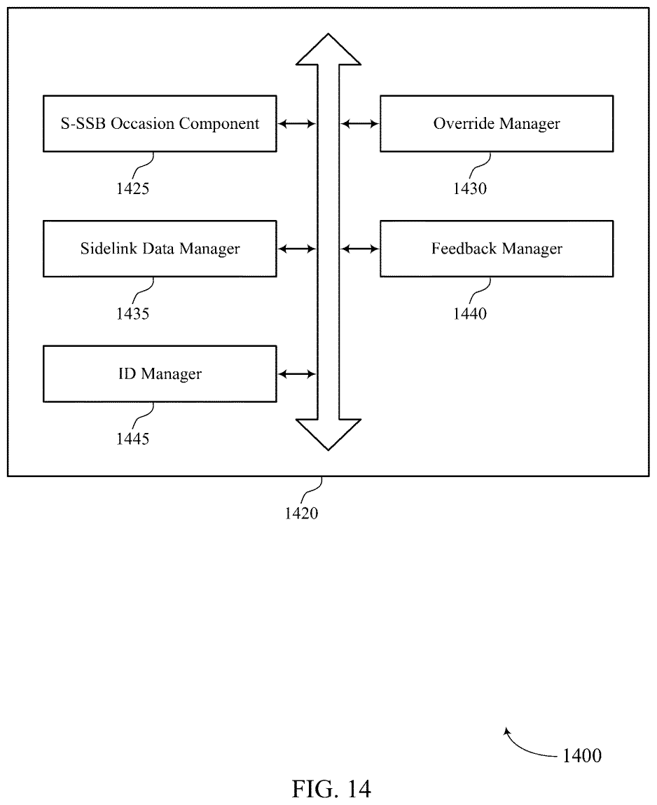

FIG. 14 shows a block diagram 1400 of a communications manager 1420 that supports data transmission availability in S-SSB occasions in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of data transmission availability in S-SSB occasions as described herein. For example, the communications manager 1420 may include an S-SSB occasion component 1425, an override manager 1430, a sidelink data manager 1435, a feedback manager 1440, an ID manager 1445, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The S-SSB occasion component 1425 is capable of, configured to, or operable to support a means for transmitting, to a first UE, a first message indicating one or more occasions associated with S-SSB transmissions between at least the first UE and a second UE. The override manager 1430 is capable of, configured to, or operable to support a means for receiving a second message that includes an indication to override a default state, the default state associated with whether the one or more occasions are available for sidelink data transmissions between at least the first UE and the second UE. The sidelink data manager 1435 is capable of, configured to, or operable to support a means for scheduling one or more sidelink data transmissions between at least the first UE and the second UE for one or more resources that are selected based on least in part on the default state being overridden.

In some examples, the ID manager 1445 is capable of, configured to, or operable to support a means for receiving, from the second UE, a third message indicating one or more Layer 2 ID values associated with the second UE, where receiving the second message is based on receiving the third message from the second UE.

In some examples, the ID manager 1445 is capable of, configured to, or operable to support a means for receiving, from the first UE, a sidelink buffer status report indicating one or more destination ID values. In some examples, the ID manager 1445 is capable of, configured to, or operable to support a means for determining that a destination identification value of the one or more destination ID values is associated with the second UE, where scheduling the one or more sidelink data transmissions is based on the determining.

In some examples, the second message indicates that the default state is overridden for a next occasion of the one or more occasions.

In some examples, the second message indicates that the default state is overridden for occasions within a current S-SSB period.

In some examples, the override manager 1430 is capable of, configured to, or operable to support a means for receiving a fourth message that includes an indication to return to the default state for occasions within the current S-SSB period.

In some examples, the default state indicates that the one or more occasions are not available for sidelink data transmissions between the first UE and the second UE, and to support scheduling the one or more sidelink data transmissions, the sidelink data manager 1435 is capable of, configured to, or operable to support a means for scheduling, based on the default state being overridden, a sidelink data transmission between at least the first UE and the second UE during an occasion of the one or more occasions based on receiving the second message.

In some examples, the default state indicates that the one or more occasions are available for sidelink data transmissions between the first UE and the second UE, and to support scheduling the one or more sidelink data transmissions, the sidelink data manager 1435 is capable of, configured to, or operable to support a means for scheduling a sidelink data transmission between at least the first UE and the second UE for a resource that is different than a next occasion of the one or more occasions based on receiving the second message.

In some examples, the indication to override the default state includes one or more bits within the second message, the second message including an uplink control message.

Additionally, or alternatively, the communications manager 1420 may support wireless communication at a network entity in accordance with examples as disclosed herein. In some examples, the S-SSB occasion component 1425 is capable of, configured to, or operable to support a means for transmitting a message indicating one or more occasions associated with S-SSB transmissions between at least a first UE and a second UE, where an upcoming occasion of the one or more occasions associated with S-SSB transmissions overlaps with an occasion for a sidelink data transmission. The feedback manager 1440 is capable of, configured to, or operable to support a means for receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

In some examples, the override manager 1430 is capable of, configured to, or operable to support a means for receiving, from the first UE, a message that includes an indication to override a default state, the default state associated with whether the one or more occasions can be used for sidelink data transmissions between at least the first UE and the second UE.

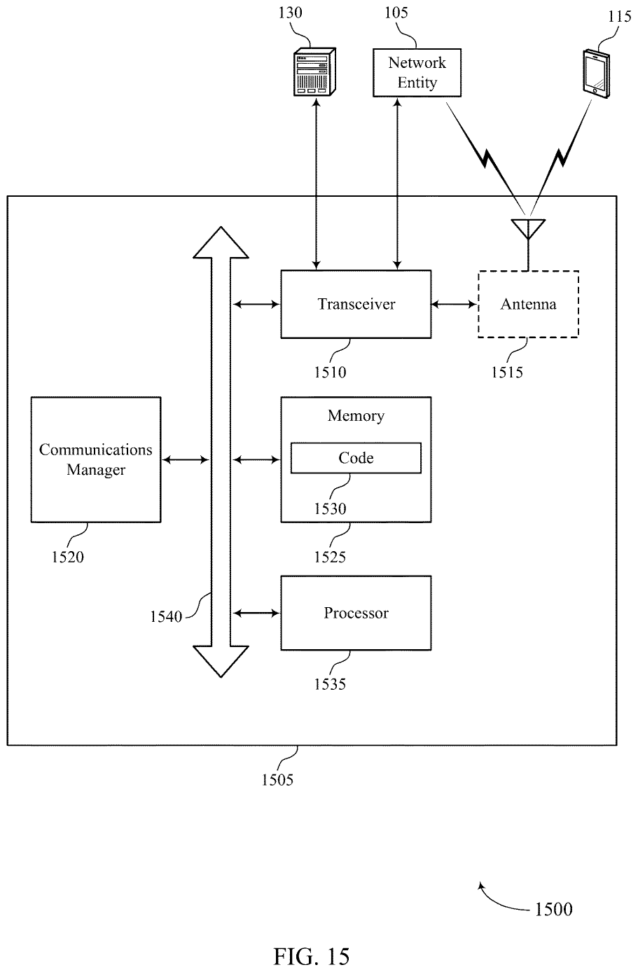

FIG. 15 shows a diagram of a system 1500 including a device 1505 that supports data transmission availability in S-SSB occasions in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting data transmission availability in S-SSB occasions). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 is capable of, configured to, or operable to support a means for transmitting, to a first UE, a first message indicating one or more occasions associated with S-SSB transmissions between at least the first UE and a second UE. The communications manager 1520 is capable of, configured to, or operable to support a means for receiving a second message that includes an indication to override a default state, the default state associated with whether the one or more occasions are available for sidelink data transmissions between at least the first UE and the second UE. The communications manager 1520 is capable of, configured to, or operable to support a means for scheduling one or more sidelink data transmissions between at least the first UE and the second UE for one or more resources that are selected based on least in part on the default state being overridden.

Additionally, or alternatively, the communications manager 1520 may support wireless communication at a network entity in accordance with examples as disclosed herein. For example, the communications manager 1520 is capable of, configured to, or operable to support a means for transmitting a message indicating one or more occasions associated with S-SSB transmissions between at least a first UE and a second UE, where an upcoming occasion of the one or more occasions associated with S-SSB transmissions overlaps with an occasion for a sidelink data transmission. The communications manager 1520 is capable of, configured to, or operable to support a means for receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission.

By including or configuring the communications manager 1520 in accordance with examples as described herein, the device 1505 may support techniques for scheduling sidelink data transmissions while avoiding overlap with S-SSB transmissions, leading to more efficient utilization of communication resources and reduced latency.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of data transmission availability in S-SSB occasions as described herein, or the processor 1535 and the memory 1525 may be otherwise configured to perform or support such operations.

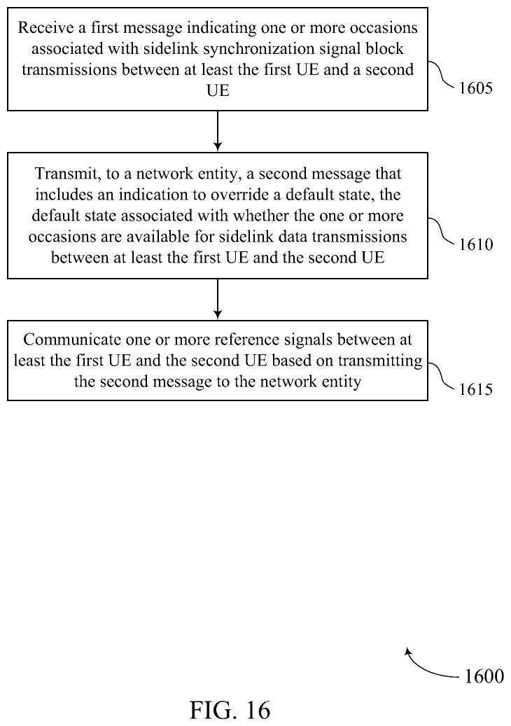

FIG. 16 shows a flowchart illustrating a method 1600 that supports data transmission availability in S-SSB occasions in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a first message indicating one or more occasions associated with S-SSB transmissions between at least the first UE and a second UE. The operations of block 1605 may be performed in accordance with examples as disclosed herein. In some examples, aspects of the operations of 1605 may be performed by an S-SSB occasion manager 1025 as described with reference to FIG. 10.

At 1610, the method may include transmitting, to a network entity, a second message that includes an indication to override a default state, the default state associated with whether the one or more occasions are available for sidelink data transmissions between at least the first UE and the second UE. The operations of block 1610 may be performed in accordance with examples as disclosed herein. In some examples, aspects of the operations of 1610 may be performed by an override component 1030 as described with reference to FIG. 10.

At 1615, the method may include communicating one or more reference signals between at least at least the first UE and the second UE based on transmitting the second message to the network entity. The operations of block 1615 may be performed in accordance with examples as disclosed herein. In some examples, aspects of the operations of 1615 may be performed by an S-SSB component 1035 as described with reference to FIG. 10.

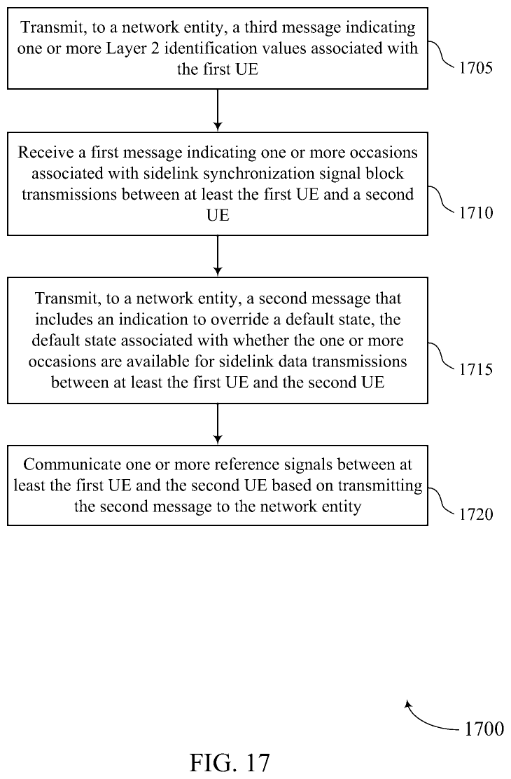

FIG. 17 shows a flowchart illustrating a method 1700 that supports data transmission availability in S-SSB occasions in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting, to a network entity, a third message indicating one or more Layer 2 ID values associated with the first UE. The operations of block 1705 may be performed in accordance with examples as disclosed herein. In some examples, aspects of the operations of 1705 may be performed by an ID component 1050 as described with reference to FIG. 10.

At 1710, the method may include receiving a first message indicating one or more occasions associated with S-SSB transmissions between at least the first UE and a second UE. The operations of block 1710 may be performed in accordance with examples as disclosed herein. In some examples, aspects of the operations of 1710 may be performed by an S-SSB occasion manager 1025 as described with reference to FIG. 10.

At 1715, the method may include transmitting, to a network entity, a second message that includes an indication to override a default state, the default state associated with whether the one or more occasions are available for sidelink data transmissions between at least the first UE and the second UE. The operations of block 1715 may be performed in accordance with examples as disclosed herein. In some examples, aspects of the operations of 1715 may be performed by an override component 1030 as described with reference to FIG. 10.

At 1720, the method may include communicating one or more reference signals between at least the first UE and the second UE based on transmitting the second message to the network entity. The operations of block 1720 may be performed in accordance with examples as disclosed herein. In some examples, aspects of the operations of 1720 may be performed by an S-SSB component 1035 as described with reference to FIG. 10.

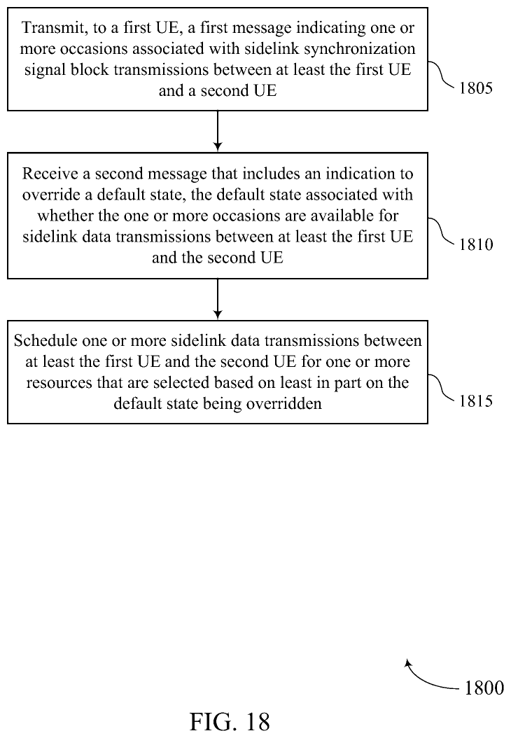

FIG. 18 shows a flowchart illustrating a method 1800 that supports data transmission availability in S-SSB occasions in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a first UE, a first message indicating one or more occasions associated with S-SSB transmissions between at least the first UE and a second UE. The operations of block 1805 may be performed in accordance with examples as disclosed herein. In some examples, aspects of the operations of 1805 may be performed by an S-SSB occasion component 1425 as described with reference to FIG. 14.

At 1810, the method may include receiving a second message that includes an indication to override a default state, the default state associated with whether the one or more occasions are available for sidelink data transmissions between at least the first UE and the second UE. The operations of block 1810 may be performed in accordance with examples as disclosed herein. In some examples, aspects of the operations of 1810 may be performed by an override manager 1430 as described with reference to FIG. 14.

At 1815, the method may include scheduling one or more sidelink data transmissions between at least the first UE and the second UE for one or more resources that are selected based on least in part on the default state being overridden. The operations of block 1815 may be performed in accordance with examples as disclosed herein. In some examples, aspects of the operations of 1815 may be performed by a sidelink data manager 1435 as described with reference to FIG. 14.

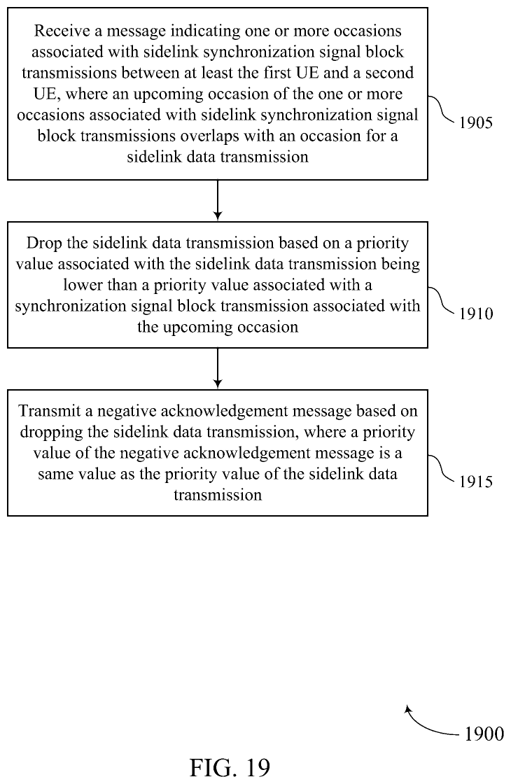

FIG. 19 shows a flowchart illustrating a method 1900 that supports data transmission availability in S-SSB occasions in accordance with aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving a message indicating one or more occasions associated with S-SSB transmissions between at least the first UE and a second UE, where an upcoming occasion of the one or more occasions associated with S-SSB transmissions overlaps with an occasion for a sidelink data transmission. The operations of block 1905 may be performed in accordance with examples as disclosed herein. In some examples, aspects of the operations of 1905 may be performed by an S-SSB component 1035 as described with reference to FIG. 10.

At 1910, the method may include dropping the sidelink data transmission based on a priority value associated with the sidelink data transmission being lower than a priority value associated with a synchronization signal block transmission associated with the upcoming occasion. The operations of block 1910 may be performed in accordance with examples as disclosed herein. In some examples, aspects of the operations of 1910 may be performed by a sidelink data component 1040 as described with reference to FIG. 10.

At 1915, the method may include transmitting a negative acknowledgment message based on dropping the sidelink data transmission, where a priority value of the negative acknowledgment message is a same value as the priority value of the sidelink data transmission. The operations of block 1915 may be performed in accordance with examples as disclosed herein. In some examples, aspects of the operations of 1915 may be performed by a feedback component 1045 as described with reference to FIG. 10.

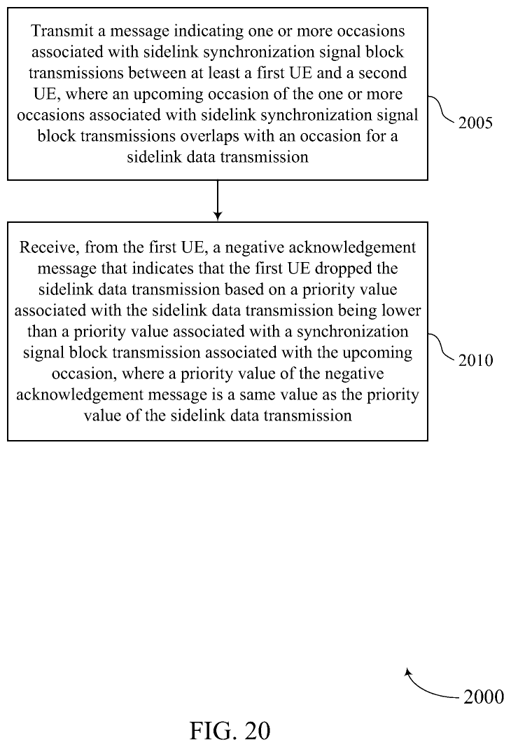

FIG. 20 shows a flowchart illustrating a method 2000 that supports data transmission availability in S-SSB occasions in accordance with aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a message indicating one or more occasions associated with S-SSB transmissions between at least a first UE and a second UE, where an upcoming occasion of the one or more occasions associated with S-SSB transmissions overlaps with an occasion for a sidelink data transmission. The operations of block 2005 may be performed in accordance with examples as disclosed herein. In some examples, aspects of the operations of 2005 may be performed by an S-SSB occasion component 1425 as described with reference to FIG. 14.

At 2010, the method may include receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, where a priority value of the negative acknowledgment message is a same value as the priority value of the sidelink data transmission. The operations of block 2010 may be performed in accordance with examples as disclosed herein. In some examples, aspects of the operations of 2010 may be performed by a feedback manager 1440 as described with reference to FIG. 14.

The following provides an overview of aspects of the present disclosure:
Aspect 1: A method for wireless communication at a first UE, comprising: receiving a first message indicating one or more occasions associated with S-SSB transmissions between at least the first UE and a second UE; transmitting, to a network entity, a second message that includes an indication to override a default state, the default state associated with whether the one or more occasions are available for sidelink data transmissions between the first UE and the second UE; and communicating one or more reference signals between at least the first UE and the second UE based at least in part on transmitting the second message to the network entity.
Aspect 2: The method of aspect 1, wherein the second message indicates that the default state is overridden for a next occasion of the one or more occasions.
Aspect 3: The method of aspect 1, wherein the second message indicates that the default state is overridden for occasions within a current S-SSB period.
Aspect 4: The method of aspect 3, further comprising: transmitting, to the network entity, a fourth message that includes an indication to return to the default state for occasions within the current S-SSB period.
Aspect 5: The method of any of aspects 1 through 4, further comprising: transmitting, to the network entity and prior to transmitting the first message, a third message indicating one or more Layer 2 ID values associated with the first UE.
Aspect 6: The method of any of aspects 1 through 5, wherein the default state indicates that the one or more occasions are available for sidelink data transmissions between the first UE and the second UE.
Aspect 7: The method of any of aspects 1 through 5, wherein the default state indicates that the one or more occasions are not available for sidelink data transmissions between the first UE and the second UE.
Aspect 8: The method of aspect 7, further comprising: transmitting, based at least in part on the default state being overridden, a sidelink data message to the second UE during a next occasion of the one or more occasions.
Aspect 9: The method of aspect 8, wherein communicating the one or more reference signals further comprises: communicating the one or more reference signals during an occasion that follows the next occasion of the one or more occasions.
Aspect 10: The method of any of aspects 7 through 9, further comprising: transmitting, to the network entity, a fourth message that includes an indication to return to the default state for occasions within a current S-SSB period, wherein communicating the one or more reference signals is based at least in part on transmitting the fourth message.
Aspect 11: The method of any of aspects 1 through 10, wherein the default state is based at least in part on a success rate associated with listen-before-talk procedures for S-SSB transmissions at the first UE.
Aspect 12: The method of any of aspects 1 through 11, wherein the indication to override the default state comprises one or more bits within the second message, the second message comprising an uplink control message.
Aspect 13: The method of aspect 12, wherein transmitting the second message further comprises: transmitting the uplink control message during a time window configured by the network entity, wherein the one or more bits comprise one or more additional bits included in the second message based at least in part on transmitting the uplink control message during the time window.
Aspect 14: The method of any of aspects 12 through 13, wherein the second message comprises a dedicated control message associated with transmitting the indication to override the default state.
Aspect 15: The method of any of aspects 1 through 14, further comprising: receiving, from the second UE, a message that includes the indication to override the default state, wherein transmitting the second message to the network entity is based at least in part on receiving the message that includes the indication to override the default state from the second UE.
Aspect 16: The method of any of aspects 1 through 15, further comprising: determining that an upcoming occasion of the one or more occasions associated with S-SSB transmissions overlaps with an occasion for a sidelink data transmission; dropping the sidelink data transmission based at least in part on a priority value associated with the sidelink data transmission being lower than a priority value associated with a S-SSB transmission associated with the upcoming occasion; and transmitting a negative acknowledgment message based at least in part on dropping the sidelink data transmission, wherein a priority value associated with the negative acknowledgment message is a same value as the priority value associated with the sidelink data transmission.
Aspect 17: A method for wireless communication at a network entity, comprising: transmitting, to a first UE, a first message indicating one or more occasions associated with S-SSB transmissions between at least the first UE and a second UE; receiving a second message that includes an indication to override a default state, the default state associated with whether the one or more occasions are available for sidelink data transmissions between the first UE and the second UE; and scheduling one or more sidelink data transmissions between at least the first UE and the second UE for one or more resources that are selected based on least in part on the default state being overridden.
Aspect 18: The method of aspect 17, further comprising: receiving, from the second UE, a third message indicating one or more Layer 2 ID values associated with the second UE, wherein receiving the second message is based at least in part on receiving the third message from the second UE.
Aspect 19: The method of aspect 18, further comprising: receiving, from the first UE, a sidelink buffer status report indicating one or more destination ID values; and determining that a destination ID value of the one or more destination ID values is associated with the second UE, wherein scheduling the one or more sidelink data transmissions is based at least in part on the determining.
Aspect 20: The method of any of aspects 17 through 19, wherein the second message indicates that the default state is overridden for a next occasion of the one or more occasions.
Aspect 21: The method of any of aspects 17 through 19, wherein the second message indicates that the default state is overridden for occasions within a current S-SSB period.
Aspect 22: The method of aspect 21, further comprising: receiving a fourth message that includes an indication to return to the default state for occasions within the current S-SSB period.
Aspect 23: The method of any of aspects 17 through 22, wherein the default state indicates that the one or more occasions are not available for sidelink data transmissions between the first UE and the second UE, and wherein scheduling the one or more sidelink data transmissions comprises: scheduling, based at least in part on the default state being overridden, a sidelink data transmission between the first UE and the second UE during an occasion of the one or more occasions based at least in part on receiving the second message.
Aspect 24: The method of any of aspects 17 through 22, wherein the default state indicates that the one or more occasions are available for sidelink data transmissions between the first UE and the second UE, and wherein scheduling the one or more sidelink data transmissions comprises: scheduling a sidelink data transmission between the first UE and the second UE for a resource that is different than a next occasion of the one or more occasions based at least in part on receiving the second message.
Aspect 25: The method of any of aspects 17 through 24, wherein the indication to override the default state comprises one or more bits within the second message, the second message comprising an uplink control message.
Aspect 26: A method for wireless communication at a first UE, comprising: receiving a message indicating one or more occasions associated with S-SSB transmissions between the first UE and a second UE, wherein an upcoming occasion of the one or more occasions associated with S-SSB transmissions overlaps with an occasion for a sidelink data transmission; dropping the sidelink data transmission based at least in part on a priority value associated with the sidelink data transmission being lower than a priority value associated with a synchronization signal block transmission associated with the upcoming occasion; and transmitting a negative acknowledgment message based at least in part on dropping the sidelink data transmission, wherein a priority value of the negative acknowledgment message is a same value as the priority value of the sidelink data transmission.
Aspect 27: The method of aspect 26, further comprising: transmitting one or more reference signals to the second UE based at least in part on dropping the sidelink data transmission.
Aspect 28: The method of any of aspects 26 through 27, further comprising: transmitting, to a network entity, a message that includes an indication to override a default state, the default state associated with whether the one or more occasions can be used for sidelink data transmissions between the first UE and the second UE.
Aspect 29: A method for wireless communication at a network entity, comprising: transmitting a message indicating one or more occasions associated with S-SSB transmissions between a first UE and a second UE, wherein an upcoming occasion of the one or more occasions associated with S-SSB transmissions overlaps with an occasion for a sidelink data transmission; and receiving, from the first UE, a negative acknowledgment message that indicates that the first UE dropped the sidelink data transmission based on a priority value associated with the sidelink data transmission being lower than a priority value associated with a synchronization signal block transmission associated with the upcoming occasion, wherein a priority value of the negative acknowledgment message is a same value as the priority value of the sidelink data transmission.
Aspect 30: The method of aspect 29, further comprising: receiving, from the first UE, a message that includes an indication to override a default state, the default state associated with whether the one or more occasions can be used for sidelink data transmissions between the first UE and the second UE.
Aspect 31: An apparatus for wireless communication at a first UE, comprising a processor; memory coupled with the processor; and instructions stored in the memory and executable by the processor to cause the apparatus to perform a method of any of aspects 1 through 16.
Aspect 32: An apparatus for wireless communication at a first UE, comprising at least one means for performing a method of any of aspects 1 through 16.
Aspect 33: A non-transitory computer-readable medium storing code for wireless communication at a first UE, the code comprising instructions executable by a processor to perform a method of any of aspects 1 through 16.
Aspect 34: An apparatus for wireless communication at a network entity, comprising a processor; memory coupled with the processor; and instructions stored in the memory and executable by the processor to cause the apparatus to perform a method of any of aspects 17 through 25.
Aspect 35: An apparatus for wireless communication at a network entity, comprising at least one means for performing a method of any of aspects 17 through 25.
Aspect 36: A non-transitory computer-readable medium storing code for wireless communication at a network entity, the code comprising instructions executable by a processor to perform a method of any of aspects 17 through 25.
Aspect 37: An apparatus for wireless communication at a first UE, comprising a processor; memory coupled with the processor; and instructions stored in the memory and executable by the processor to cause the apparatus to perform a method of any of aspects 26 through 28.
Aspect 38: An apparatus for wireless communication at a first UE, comprising at least one means for performing a method of any of aspects 26 through 28.
Aspect 39: A non-transitory computer-readable medium storing code for wireless communication at a first UE, the code comprising instructions executable by a processor to perform a method of any of aspects 26 through 28.
Aspect 40: An apparatus for wireless communication at a network entity, comprising a processor; memory coupled with the processor; and instructions stored in the memory and executable by the processor to cause the apparatus to perform a method of any of aspects 29 through 30.
Aspect 41: An apparatus for wireless communication at a network entity, comprising at least one means for performing a method of any of aspects 29 through 30.
Aspect 42: A non-transitory computer-readable medium storing code for wireless communication at a network entity, the code comprising instructions executable by a processor to perform a method of any of aspects 29 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor;
memory coupled with the processor; and
instructions stored in the memory and executable by the processor to cause the apparatus to:
receive a first message indicating one or more occasions associated with sidelink synchronization signal block transmissions between at least the first UE and a second UE;
transmit, to a network entity, a second message that includes an indication to override a default state, the default state associated with whether the one or more occasions are available for sidelink data transmissions between at least the first UE and the second UE; and
communicate one or more reference signals between at least the first UE and the second UE based at least in part on transmitting the second message to the network entity.

2. The apparatus of claim 1, wherein the second message indicates that the default state is overridden for a next occasion of the one or more occasions.

3. The apparatus of claim 1, wherein the second message indicates that the default state is overridden for occasions within a current sidelink synchronization signal block period.

4. The apparatus of claim 3, wherein the instructions are further executable by the processor to cause the apparatus to:
transmit, to the network entity, a fourth message that includes an indication to return to the default state for occasions within the current sidelink synchronization signal block period.

5. The apparatus of claim 1, wherein the instructions are further executable by the processor to cause the apparatus to:
transmit, to the network entity and prior to receiving the first message, a third message indicating one or more Layer 2 identification values associated with the first UE.

6. The apparatus of claim 1, wherein the default state indicates that the one or more occasions are available for sidelink data transmissions between at least the first UE and the second UE.

7. The apparatus of claim 1, wherein the default state indicates that the one or more occasions are not available for sidelink data transmissions between at least the first UE and the second UE.

8. The apparatus of claim 7, wherein the instructions are further executable by the processor to cause the apparatus to:
transmit, based at least in part on the default state being overridden, a sidelink data message to the second UE during a next occasion of the one or more occasions.

9. The apparatus of claim 8, wherein the instructions to communicate the one or more reference signals are further executable by the processor to cause the apparatus to:
communicate the one or more reference signals during an occasion that follows the next occasion of the one or more occasions.

10. The apparatus of claim 7, wherein the instructions are further executable by the processor to cause the apparatus to:
transmit, to the network entity, a fourth message that includes an indication to return to the default state for occasions within a current sidelink synchronization signal block period, wherein communicating the one or more reference signals is based at least in part on transmitting the fourth message.

11. The apparatus of claim 1, wherein the default state is based at least in part on a success rate associated with listen-before-talk procedures for sidelink synchronization signal block transmissions at the first UE.

12. The apparatus of claim 1, wherein the indication to override the default state comprises one or more bits within the second message, the second message comprising an uplink control message.

13. The apparatus of claim 12, wherein, to transmit the second message, the instructions are executable by the processor to cause the apparatus to:
transmit the uplink control message during a time window configured by the network entity, wherein the one or more bits comprise one or more additional bits included in the second message based at least in part on transmitting the uplink control message during the time window.

14. The apparatus of claim 12, wherein the second message comprises a dedicated control message associated with transmitting the indication to override the default state.

15. The apparatus of claim 1, wherein the instructions are further executable by the processor to cause the apparatus to:
receive, from the second UE, a message that includes the indication to override the default state, wherein transmitting the second message to the network entity is based at least in part on receiving the message that includes the indication to override the default state from the second UE.

16. The apparatus of claim 1, wherein the instructions are further executable by the processor to cause the apparatus to:
determine that an upcoming occasion of the one or more occasions associated with sidelink synchronization signal block transmissions overlaps with an occasion for a sidelink data transmission;
drop the sidelink data transmission based at least in part on a priority value associated with the sidelink data transmission being lower than a priority value associated with a sidelink synchronization signal block transmission associated with the upcoming occasion; and
transmit a negative acknowledgment message based at least in part on dropping the sidelink data transmission, wherein a priority value associated with the negative acknowledgment message is a same value as the priority value associated with the sidelink data transmission.

17. An apparatus for wireless communication at a network entity, comprising:
a processor;
memory coupled with the processor; and
instructions stored in the memory and executable by the processor to cause the apparatus to:
transmit, to a first user equipment (UE), a first message indicating one or more occasions associated with sidelink synchronization signal block transmissions between at least the first UE and a second UE;
receive a second message that includes an indication to override a default state, the default state associated with whether the one or more occasions are available for sidelink data transmissions between at least the first UE and the second UE; and
schedule one or more sidelink data transmissions between at least the first UE and the second UE for one or more resources that are selected based on least in part on the default state being overridden.

18. The apparatus of claim 17, wherein the instructions are further executable by the processor to cause the apparatus to:
receive, from the second UE, a third message indicating one or more Layer 2 identification values associated with the second UE, wherein receiving the second message is based at least in part on receiving the third message from the second UE.

19. The apparatus of claim 18, wherein the instructions are further executable by the processor to cause the apparatus to:
receive, from the first UE, a sidelink buffer status report indicating one or more destination identification values; and
determine that a destination identification value of the one or more destination identification values is associated with the second UE, wherein scheduling the one or more sidelink data transmissions is based at least in part on the determining.

20-25. (canceled)

26. An apparatus for wireless communication at a first user equipment (UE), comprising:
a processor;
memory coupled with the processor; and
instructions stored in the memory and executable by the processor to cause the apparatus to:
receive a message indicating one or more occasions associated with sidelink synchronization signal block transmissions between at least the first UE and a second UE, wherein an upcoming occasion of the one or more occasions associated with sidelink synchronization signal block transmissions overlaps with an occasion for a sidelink data transmission;
drop the sidelink data transmission based at least in part on a priority value associated with the sidelink data transmission being lower than a priority value associated with a synchronization signal block transmission associated with the upcoming occasion; and
transmit a negative acknowledgment message based at least in part on dropping the sidelink data transmission, wherein a priority value of the negative acknowledgment message is a same value as the priority value of the sidelink data transmission.

27-30. (canceled)
